(19) United States
(12) Patent Application Publication
(10) Pub. No.: US 2010/0323192 A1
(43) Pub. Date: Dec. 23, 2010

(54) BASE MEMBER INCLUDING BONDING FILM, BONDING METHOD AND BONDED BODY

(75) Inventors: Yasuhide Matsuo, Nagano (JP); Kenji Otsuka, Nagano (JP); Kazuo Higuchi, Nagano (JP); Kosuke Wakamatsu, Nagano (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/668,108

(22) PCT Filed: Jul. 2, 2008
(86) PCT No.: PCT/JP2008/062008

§ 371 Date: Jan. 7, 2010

(30) Foreign Application Priority Data
Jul. 11, 2007 (JP) 2007-182677
May 21, 2008 (JP) 2008-133672

(51) Int. Cl. C09J 5/06; B32B 37/16; B32B 38/00; C09J 5/02; B32B 9/00

(52) U.S. Cl. 428/336; 156/306.6; 156/272.2; 428/355 R; 428/345; 428/354; 428/349

(57) ABSTRACT

A base member including a bonding film comprises a substrate; and
the bonding film provided on the substrate. The base member is capable of bonding to an opposite substrate (object) through the bonding film. Such a bonding film contains a Si-skeleton constituted of constituent atoms containing silicon atoms and elimination groups bonded to the silicon atoms of the Si-skeleton. The Si-skeleton includes siloxane (Si—O) bonds. The constituent atoms are bonded to each other. Further, the bonding film is formed by a plasma polymerization. Furthermore, in a case where energy is applied to at least a part region of the surface of the bonding film, the elimination groups existing on the surface and in the vicinity of the surface within the region are removed from the silicon atoms of the Si-skeleton so that the region develops a bonding property with respect to the opposite substrate.

### CROSS-REFERENCE TO RELATED APPLICATION

This application claims a priority to Japanese Patent Application No. 2007-182677 filed on Jul. 11, 2007 and Japanese Patent Application No. 2008-133672 filed on May 21, 2008 which are hereby expressly incorporated by reference herein in their entireties.

### BACKGROUND

1. Technical Field

The present invention relates to a base member including a bonding film, a bonding method and a bonded body.

2. Related Art

Conventionally, in the case where two members (base members) are bonded together, an adhesive such as an epoxy-based adhesive, an urethane-based adhesive, or a silicone-based adhesive has been often used.

In general, an adhesive exhibits reliably high adhesiveness regardless of constituent materials of the members to be bonded. Therefore, members formed of various materials can be bonded together in various combinations.

For example, a droplet ejection head (an ink-jet type recording head) included in an ink-jet printer is assembled by bonding, using an adhesive, several members formed of different kinds of materials such as a resin-based material, a metal-based material, and a silicon-based material.

When the members are to be bonded together using the adhesive to obtain an assembled body composed from the members, a liquid or paste adhesive is applied to surfaces of the members, and then the members are attached to each other via the applied adhesive on the surfaces thereof and firmly fixed together by hardening (setting) the adhesive with an action of heat or light.

However, in such an adhesive, there are problems in that bonding strength between the members is low, dimensional accuracy of the obtained assembled body is low, and it takes a relatively long time until the adhesive is hardened.

Further, it is often necessary to treat the surfaces of the members to be bonded using a primer in order to improve the bonding strength between the members. Therefore, additional cost and labor hour are required for performing the primer treatment, which causes an increase in cost and complexity of the process for bonding the members.

On the other hand, as a method of bonding members without using the adhesive, there is known a solid bonding method. The solid bonding method is a method of directly bonding members without an intervention of an intermediate layer composed of an adhesive or the like (see, for example, the following Patent Document).

Since such a solid bonding method does not need to use the intermediate layer composed of the adhesive or the like for bonding the members, it is possible to obtain a bonded body of the members having high dimensional accuracy.

However, in the case where the members are bonded together by using the solid bonding method, there are problems in that constituent materials of the members to be bonded are limited to specific kinds, a heat treatment having a high temperature (e.g., about 700 to 800° C.) must be carried out in a bonding process, and an atmosphere in the bonding process is limited to a reduced atmosphere.

In view of such problems, there is a demand for a method which is capable of firmly bonding members with high dimensional accuracy and efficiently bonding them at a low temperature regardless of constituent materials of the members to be bonded.

The patent document is JP A-5-82404 as an example of related art.

### SUMMARY

Accordingly, it is an object of the present invention to provide a base member including a bonding film (hereinafter, simply referred to as “a base member”) that can be firmly bonded to an object with high dimensional accuracy and efficiently bonded to the object at a low temperature, a bonding method which is capable of efficiently bonding such a base member and the object at a low temperature, and a bonded body formed by firmly bonding the base member and the object with high dimensional accuracy and therefore being capable of providing high reliability.

A first aspect of the present invention is directed to a base member including a bonding film. The base member is to be bonded to an object through the bonding film. The base member comprises: a substrate; and the bonding film provided on the substrate.

The bonding film contains a Si-skeleton constituted of constituent atoms containing silicon atoms and elimination groups bonded to the silicon atoms of the Si-skeleton. The Si-skeleton includes siloxane (Si—O) bonds. The constituent atoms are bonded to each other. The bonding film is formed by a plasma polymerization.

In a case where an energy is applied to at least a part region of the surface of the bonding film, the elimination groups existing on the surface and in the vicinity of the surface within the region are removed from the silicon atoms of the Si-skeleton so that the region develops a bonding property with respect to the object.

According to such a base member, it is possible to obtain a base member including a bonding film that can be firmly bonded to the object with high dimensional accuracy and efficiently bonded to the object at a low temperature.

In the above base member, it is preferred that the constituent atoms have hydrogen atoms and oxygen atoms, a sum of a content of the silicon atoms and a content of the oxygen atoms in the constituent atoms other than the hydrogen atoms is in the range of 10 to 90 atom % in the bonding film.

According to such a base member, the bonding film makes it possible to form a firm network by the silicon atoms and the oxygen atoms, so that the bonded film becomes hard in itself. Therefore, the bonding film makes it possible to have high bonding strength with respect to the base member and the object.

In the above base member, it is also preferred that the constituent atoms have oxygen atoms, and an abundance ratio of the silicon atoms and the oxygen atoms is in the range of 3:7 to 7:3 in the bonding film.

This makes it possible for the bonding film to have high stability, and thus is possible to firmly bond the base member and the object together.

In the above base member, it is also preferred that a crystallinity degree of the Si-skeleton is equal to or lower than 45%.

This makes it possible for the constituent atoms of the Si-skeleton to bond to each other, and thus it is possible to obtain a bonding film having superior dimensional accuracy and bonding property.

In the above base member, it is also preferred that the Si-skeleton of the bonding film contains Si—H bonds.

Since it is considered that the Si—H bonds prevent the siloxane bonds from being regularly produced, the siloxane bonds are formed so as to avoid the Si—H bonds. The constituent atoms constituting the Si-skeleton are bonded to each other in low regularity. That is, the constituent atoms are bonded. In this way, inclusion of the Si—H in the bonding film makes it possible to efficiently form the Si-skeleton having a low crystallinity degree.

In the above base member, it is also preferred that in the case where the bonding film containing the Si-skeleton containing the Si—H bonds is subjected to an infrared absorption measurement by an infrared adsorption measurement apparatus to obtain an infrared absorption spectrum having peaks.

In a case where an intensity of the peak derived from the siloxane bond in the infrared absorption spectrum is defined as “1”, an intensity of the peak derived from the Si—H bond in the infrared absorption spectrum is in the range of 0.001 to 0.2.

This makes it possible to obtain a bonding film having a structure in which the constituent atoms are most bonded relatively. Therefore, it is possible to obtain the bonding film having superior bonding strength, chemical resistance and dimensional accuracy.

In the above base member, it is also preferred that the elimination groups are constituted of at least one selected from the group consisting of a hydrogen atom, a boron atom, a carbon atom, a nitrogen atom, an oxygen atom, a phosphorus atom, a sulfur atom, a halogen-based atom and an atom group which is arranged so that these atoms are bonded to the Si-skeleton.

These elimination groups have relatively superior selectivity in bonding and eliminating to and from the silicon atoms of the Si-skeleton by applying energy thereto.

Therefore, the elimination groups can be eliminated from the bonding film relatively easily and uniformly by applying the energy thereto, which makes it possible to further improve a bonding property of the base member.

In the above base member, it is also preferred that the elimination groups are an alkyl group containing a methyl group.

According to such a base member, the bonding film having the alkyl groups as the elimination groups can have excellent weather resistance and chemical resistance.

In the above base member, it is also preferred that in the case where the bonding film containing the methyl groups as the elimination groups is subjected to an infrared absorption measurement by an infrared absorption measurement apparatus to obtain an infrared absorption spectrum having peaks.

In a case where an intensity of the peak derived from the siloxane bond in the infrared absorption spectrum is defined as “1”, an intensity of the peak derived from the methyl group in the infrared absorption spectrum is in the range of 0.05 to 0.45.

This makes it possible to optimize a content of the methyl group as the elimination groups, thereby preventing the methyl group from end-capping the oxygen atoms of the siloxane bonds over a necessary degree. Therefore, since necessary and sufficient active hands exist in the bonding film, sufficient bonding property is developed in the bonding film. Further, the bonding film can have sufficient weather resistance and chemical resistance which are derived from the methyl group.

In the above base member, it is also preferred that active hands are generated on the silicon atoms of the Si-skeleton of the bonding film, after the elimination groups existing at least in the vicinity of the surface of the bonding film are removed from the silicon atoms of the Si-skeleton.

This makes it possible to obtain a base member that can be firmly bonded to the object on the basis of chemical bonds.

In the above base member, it is also preferred that the active hands are dangling bonds or hydroxyl groups.

This makes it possible for the base member to be especially firmly bonded to the object.

In the above base member, it is also preferred that the bonding film is constituted of polyorganosiloxane as a main component of the bonding film.

This makes it possible to obtain a bonding film having superior bonding property. Further, the bonding film exhibits superior chemical resistance and weather resistance. Such a bonding film can be effectively used in bonding base members which are exposed to chemicals for a long period of time.

In the above base member, it is also preferred that the polyorganosiloxane is constituted of a polymer of octamethyltrisiloxane as a main component of the polyorganosiloxane.

This makes it possible to obtain the bonding film having superior bonding property.

In the above base member, it is also preferred that the plasma polymerization includes a high frequency applying process and a plasma generation process, and a power density of the high frequency during the plasma generation process is in the range of 0.01 to 100 W/cm².

This makes it possible to prevent excessive plasma energy from being applied to a raw gas due to too high output density of the high frequency. Further, it is also possible to reliably form the Si-skeleton in which the constituent atoms are bonded.

In the above base member, it is also preferred that an average thickness of the bonding film is in the range of 1 to 1000 nm.

This makes it possible to prevent dimensional accuracy of the bonded body obtained by bonding the base member and the object together from being significantly reduced, thereby enabling to more firmly bond them together.

In the above base member, it is also preferred that the bonding film is a solid-state film having no fluidity.

In this case, dimensional accuracy of the bonded body obtained by bonding the base member and the object together becomes extremely high as compared to a conventional bonded body obtained using an adhesive. Further, it is possible to firmly bond the base member to the object in a short period of time as compared to the conventional bonded body.

In the above base member, it is also preferred that a refractive index of the bonding film is in the range of 1.35 to 1.6.

A refractive index of such a bonding film is relatively close to a refractive index of crystal or quarts glass. Therefore, such a bonding film is preferably used for manufacturing optical elements having a structure so as to pass through the bonding film.

In the above base member, it is also preferred that the substrate has a plate shape.

In this case, the base member can easily bend. Therefore, the base member becomes sufficiently bendable according to a shape of the object. This makes it possible to improve bonding strength between the base member and the object. Further, since the base member can easily bend, stress which would be generated in a bonding surface therebetween can be reduced to some extent.

In the above base member, it is also preferred that at least a portion of the substrate on which the bonding film is formed is constituted of a silicon material, a metal material or a glass material as a main component of the substrate.

This makes it possible to improve bonding strength of the bonding film against the substrate, even if the substrate is not subjected to a surface treatment.

In the above base member, it is also preferred that the substrate has a surface on which the bonding film is provided, and the surface of the substrate has been, in advance, subjected to a surface treatment for improving bonding strength between the substrate and the bonding film.

By doing so, the surface of the base member can be cleaned and activated. This makes it possible to improve bonding strength between the base member (bonding film) and the object (opposite substrate).

In the above base member, it is also preferred that the surface treatment is a plasma treatment.

Use of the plasma treatment makes it possible to particularly optimize the surface of the base member so as to form the bonding film thereon.

In the above base member, it is also preferred that the base member further comprises an intermediate layer provided between the substrate and the bonding film.

This makes it possible to obtain a bonded body having high reliability.

In the above base member, it is also preferred that the intermediate layer is constituted of an oxide-based material as a main component of the intermediate layer.

This makes it possible to particularly improve bonding strength between the substrate and the bonding film.

A second aspect of the present invention is directed to a bonding method of forming a bonded body. The bonding method comprises: providing the base member defined in claim 1 and the object; applying an energy to at least the part region of the surface of the bonding film included in the base member so that the region develops a bonding property with respect to the object; and making the object and the base member close contact with each other through the bonding film, so that the object and the base member are bonded together due to the bonding property developed in the region, to thereby obtain the bonded body.

According to such a bonding method of the present invention, it is possible to efficiently bond the base member and the object under a low temperature.

A third aspect of the present invention is directed to a bonding method of forming a bonded body. The bonding method comprises: providing the base member defined in claim 1 and the object; making the object and the base member close contact with each other through the bonding film to obtain a pre-bonded body in which the object and the base member are laminated together; and applying an energy to at least the part region of the surface of the bonding film in the pre-bonded body, so that the region develops a bonding property with respect to the object and the object and the base member are bonded together due to the bonding property developed in the region, to thereby obtain the bonded body.

According to such a bonding method of the present invention, it is possible to efficiently bond the base member and the object under a low temperature. Further, in the state of the pre-bonded body, the base member and the object are not bonded together. This makes it possible to finely adjust a relative position of the base member with relative to the object easily after they have been laminated together. As a result, it becomes possible to increase positional accuracy of the base member with relative to the object in a direction of the surface of the bonding film.

In the above bonding method, it is preferred that the applying the energy is carried out by at least one method selected from the group comprising a method in which an energy beam is irradiated on the bonding film, a method in which the bonding film is heated and a method in which a compressive force is applied to the bonding film.

Use of this method makes it possible to relatively easily and efficiently apply the energy to the bonding film.

In the above bonding method, it is also preferred that the energy beam is an ultraviolet ray having a wavelength of 150 to 300 nm.

Use of the ultraviolet ray having such a wavelength makes it possible to optimize an amount of the energy to be applied to the bonding film. Therefore, it is possible to selectively cut bonds between the silicon atoms of the Si-skeleton and the elimination groups, while preventing the Si-skeleton included in the bonding film from being broken more than necessary.

As a result, it is possible for the bonding film to develop a bonding property, while preventing characteristics thereof such as mechanical characteristics or chemical characteristics from being reduced.

In the above bonding method, it is also preferred that a temperature of the heating is in the range of 25 to 100° C.

This makes it possible to reliably improve bonding strength between the base member and the object, while reliably preventing the bonded body from being thermally altered and deteriorated due to the heat.

In the above bonding method, it is also preferred that the compressive force is in the range of 0.2 to 10 MPa.

This makes it possible to reliably improve bonding strength between the base member and the object, while preventing occurrence of damages and the like in the substrate or the object due to an excess pressure.

In the above bonding method, it is also preferred that the applying the energy is carried out in an atmosphere.

By doing so, it becomes unnecessary to spend labor hour and cost for controlling the atmosphere. This makes it possible to easily perform the application of the energy.

In the above bonding method, it is also preferred that the object has a surface which has been, in advance, subjected to a surface treatment for improving bonding strength between the object and the base member, and wherein the bonding film included in the base member makes close contact with the surface-treated surface of the object.

This make it possible to improve the bonding strength between the base member and the object.

In the above bonding method, it is also preferred that the object has a surface containing at least one group or substance selected from the group comprising a functional group, a radical, an open circular molecule, an unsaturated bond, a halogen atom and peroxide, and wherein the bonding film included in the base member makes close contact with the surface having the group or substance of the object.

This make it possible to sufficiently improve bonding strength between the base member and the object.

In the above bonding method, it is also preferred that the bonding method further comprises subjecting the bonded body to a treatment for improving bonding strength between the base member and the object.

This makes it possible to further improve the bonding strength between the base member and the object.

In the above bonding method, it is also preferred that the subjecting the bonded body to the treatment is carried out by at least one method selected from the group comprising a method in which an energy beam is irradiated on the bonded body, a method in which the bonded body is heated and a method in which a compressive force is applied to the bonded body.

This makes it possible to further improve the bonding strength between the base member and the object.

A fourth aspect of the present invention is directed to a bonded body. The bonded body comprises the base member described above; and an object bonded to the base member through the bonding film of the base member.

According to such a bonded body of the present invention, it is possible to obtain a bonded body formed by firmly bonding the base member and the object with high dimensional accuracy. Such a bonded body can have high reliability.

### BRIEF DESCRIPTION OF THE DRAWINGS

FIGS. 1A to 1C are longitudinal sectional views for explaining a first embodiment of a bonding method of bonding a base member according to the present invention to an opposite substrate (object).

FIGS. 2D to 2F are longitudinal sectional views for explaining a first embodiment of a bonding method of bonding a base member according to the present invention to an opposite substrate (object).

FIG. 3 is a partially enlarged view showing a state that before energy is applied to a bonding film of the base member according to the present invention.

FIG. 4 is a partially enlarged view showing a state that after energy is applied to a bonding film of a base member according to the present invention.

FIG. 5 is a vertical section view schematically showing a plasma polymerization apparatus used for a bonding method according to the present invention.

FIGS. 6A to 6C are longitudinal sectional views for explaining a method of forming a bonding film on a substrate.

FIGS. 7A to 7D are longitudinal sectional views for explaining a second embodiment of a bonding method of bonding a base member according to the present invention to an opposite substrate (object).

FIGS. 8A to 8D are longitudinal sectional views for explaining a third embodiment of a bonding method of bonding a base member according to the present invention to an opposite substrate (object).

FIGS. 9E and 9F are longitudinal sectional views for explaining a third embodiment of a bonding method of bonding a base member according to the present invention to an opposite substrate (object).

FIGS. 10A to 10D are longitudinal sectional views for explaining a fourth embodiment of a bonding method of bonding a base member according to the present invention to an opposite substrate (object).

FIGS. 11A to 11D are longitudinal sectional views for explaining a fifth embodiment of a bonding method of bonding a base member according to the present invention to an opposite substrate (object).

FIGS. 12A to 12D are longitudinal sectional views for explaining a sixth embodiment of a bonding method of bonding a base member according to the present invention to an opposite substrate (object).

FIGS. 13A to 13D are longitudinal sectional views for explaining a seventh embodiment of a bonding method of bonding a base member according to the present invention to an opposite substrate (object).

FIG. 14 is an exploded perspective view showing an ink jet type recording head (a droplet ejection head) in which the bonded body according to the present invention is used.

FIG. 15 is a section view illustrating major parts of the ink jet type recording head shown in FIG. 14.

FIG. 16 is a schematic view showing one embodiment of an ink jet printer equipped with the ink jet type recording head shown in FIG. 14.

### DESCRIPTION OF EXEMPLARY EMBODIMENTS

Hereinafter, a base member including a bonding film (hereinafter, simply referred to as “a base member”), a bonding method, and a bonded body according to the present invention will be described in detail with reference to preferred embodiments shown in the accompanying drawings.

The base member of the present invention has a substrate and the bonding film provided on the substrate. The base member is used for bonding the substrate to an opposite substrate, that is, an object to be bonded to the base member (hereinafter, simply referred to as “an object” on occasion).

In this regard, this bonding state of the substrate and the opposite substrate will be referred as the expression “the base member is bonded to the opposite substrate (the object)”.

The bonding film included in the base member contains an Si-skeleton having siloxane bonds (Si—O), of which constituent atoms are bonded to each other, and elimination groups bonding to silicon atoms of the Si-skeleton.

In the base member having such a bonding film, in a case where energy is applied to at least a part of a predetermined region of a surface of the bonding film in a plan view thereof, that is, a whole region or a partial region of the surface of the bonding film in the plan view thereof, the elimination groups, which exist in at least the vicinity of the surface within the region, are removed (left) from the Si skeleton of the bonding film.

This bonding film has characteristics that the region of the surface, to which the energy has been applied, develops a bonding property with respect to the opposite substrate (object) due to the removal (eliminating) of the elimination groups.

According to the present invention, it is possible for the base member having the characteristics described above to firmly bond to the opposite substrate with high dimensional accuracy and to efficiently bond to the opposite substrate at a low temperature.

In addition, by using such a base member, it is possible to obtain a bonded body having high reliability, in which the substrate and the opposite substrate are firmly bonded together through the bonding film.

### First Embodiment

First, a description will be made on a first embodiment of each of the base member of the present invention, a bonding method of bonding the base member and the opposite substrate (object) together, that is, the bonding method of the present invention, and the bonded body of the present invention including the above base member.

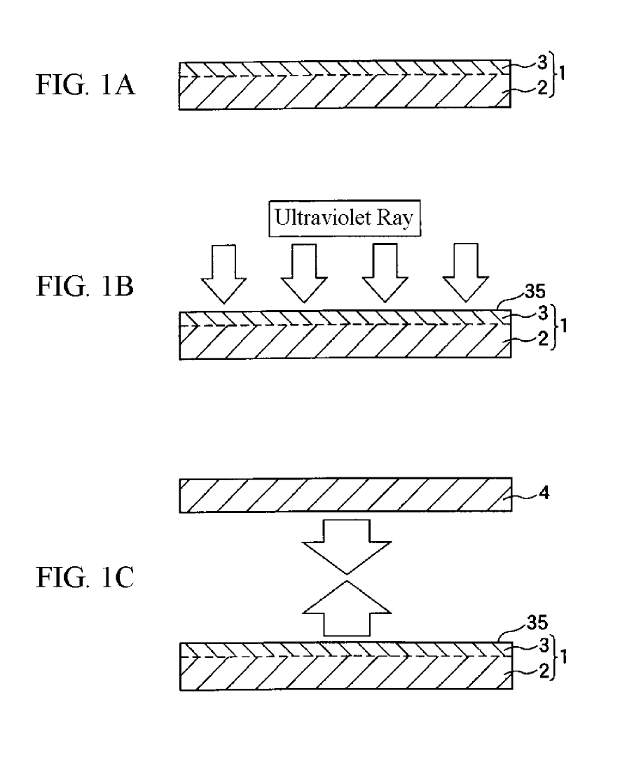

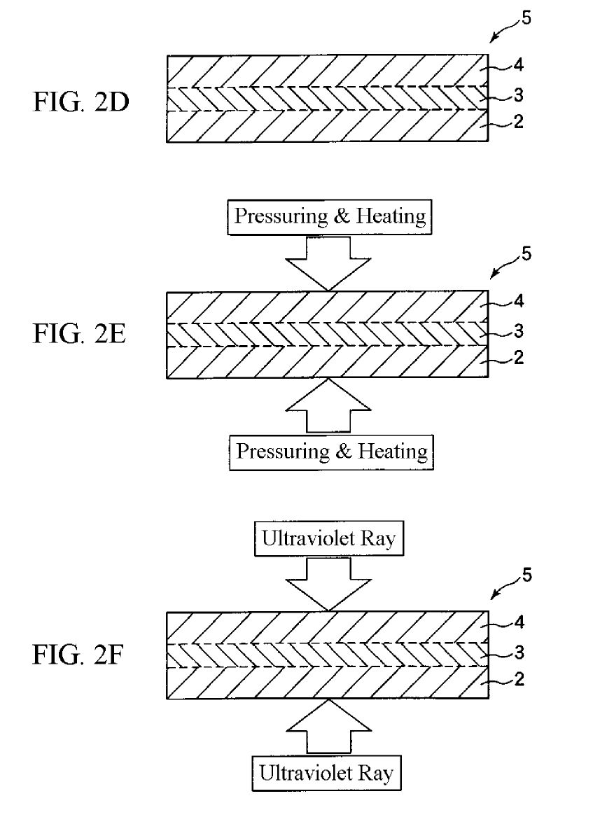

FIGS. 1A to 1C and 2D to 2F are longitudinal sectional views for explaining a first embodiment of a bonding method of bonding a base member according to the present invention to an opposite substrate (object).

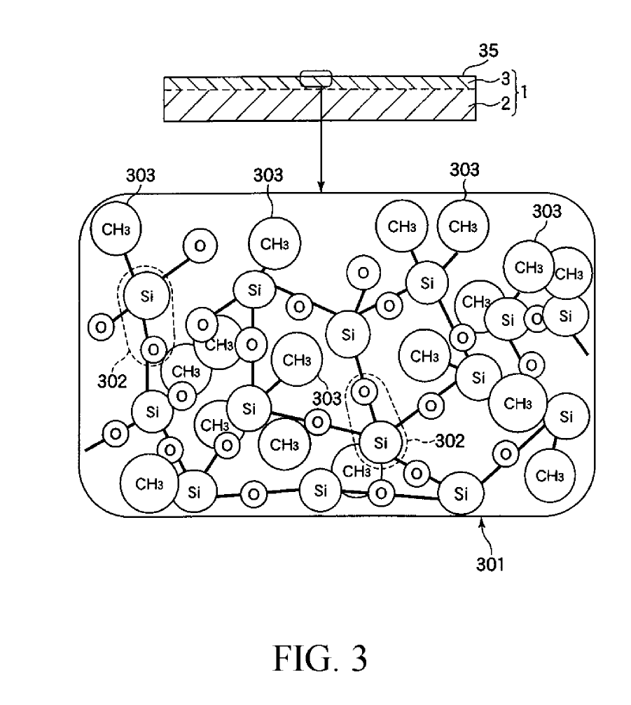

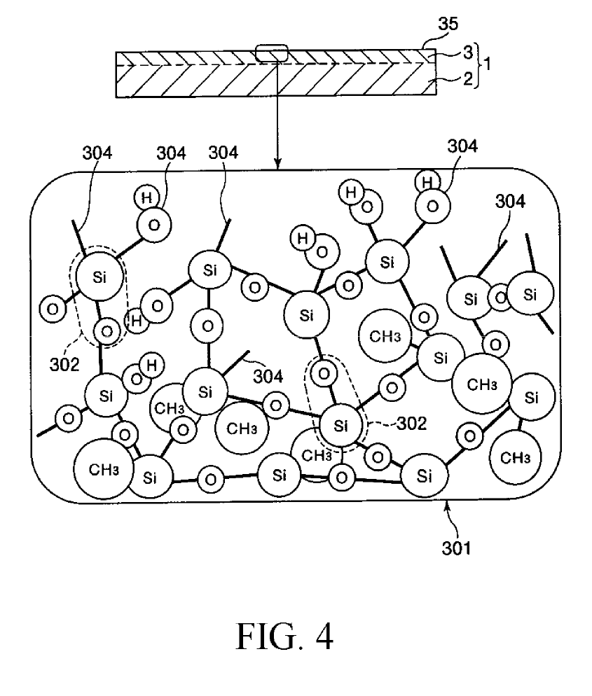

FIG. 3 is a partially enlarged view showing a state that before energy is applied to a bonding film of the base member according to the present invention. FIG. 4 is a partially enlarged view showing a state that after energy is applied to a bonding film of a base member according to the present invention.

In this regard, it is to be noted that in the following description, an upper side in each of FIGS. 1A to 1C, 2D to 2F, 3 and 4 will be referred to as “upper” and a lower side thereof will be referred to as “lower”.

The bonding method according to this embodiment includes a step of providing (preparing) the base member and the opposite substrate, a step of applying energy to a bonding film of the base member so that it is activated by eliminating elimination groups from silicon atoms of a Si-skeleton, and a step of making the prepared opposite substrate and the base member close contact with each other through the bonding film so that they are bonded together, to thereby obtain a bonded body.

Hereinafter, the respective steps of the bonding method according to this embodiment will be described one after another.

[1] First, the base member 1 (the base member according to the present invention) is prepared.

As shown in FIG. 1A, the base member 1 includes a substrate (a base) 2 having a plate shape and a bonding film 3 provided on the substrate 2. The substrate 2 may be composed of any material, as long as it has such stiffness that can support the bonding film 3.

Especially, examples of a constituent material of the substrate 2 include: a resin-based material such as polyolefin (e.g., polyethylene, polypropylene, ethylene-propylene copolymer, ethylene-vinyl acetate copolymer (EVA)), cyclic polyolefin, denatured polyolefin, polyvinyl chloride, polyvinylidene chloride, polystyrene, polyamide, polyimide, polyamide-imide, polycarbonate, poly-(4-methylpentene-1), ionomer, acrylic resin, polymethyl methacrylate, acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyester (e.g., polyethylene terephthalate (PET), polyethylene naphthalate, polybutylene terephthalate (PBT), polycyclohexane terephthalate (PCT)), polyether, polyether ketone (PEK), polyether ether ketone (PEEK), polyether imide, polyacetal (POM), polyphenylene oxide, denatured polyphenylene oxide, polysulfone, polyether sulfone, polyphenylene sulfide, polyarylate, liquid crystal polymer (e.g., aromatic polyester), fluoro resin (e.g., polytetrafluoroethylene, polyfluorovinylidene), thermoplastic elastomer (e.g., styrene-based elastomer, polyolefin-based elastomer, polyvinylchloride-based elastomer, polyurethane-based elastomer, polyester-based elastomer, polyamide-based elastomer, polybutadiene-based elastomer, trans-polyisoprene-based elastomer, fluororubber-based elastomer, chlorinated polyethylene-based elastomer), epoxy resin, phenolic resin, urea resin, melamine resin, aramid resin, unsaturated polyester, silicone resin, polyurethane, or a copolymer, a blended body and a polymer alloy each having at least one of these materials as a major component thereof; a metal-based material such as a metal (e.g., Fe, Ni, Co, Cr, Mn, Zn, Pt, Au, Ag, Cu, Pd, Al, W, Ti, V, Mo, Nb, Zr, Pr, Nd, Sm), an alloy containing at least one of these metals, carbon steel, stainless steel, indium tin oxide (ITO) or gallium arsenide; a semiconductor-based material such as Si, Ge, InP or GaPN; a silicon-based material such as monocrystalline silicon, polycrystalline silicon or amorphous silicon; a glass-based material such as silicic acid glass (quartz glass), silicic acid alkali glass, soda lime glass, potash lime glass, lead (alkaline) glass, barium glass or borosilicate glass; a ceramic-based material such as alumina, zirconia, ferrite, silicon nitride, aluminum nitride, boron nitride, titanium nitride, carbon silicon, boron carbide, titanium carbide or tungsten carbide; a carbon-based material such as graphite; a complex material containing any one kind of the above materials or two or more kinds of the above materials; and the like.

Further, a surface of the substrate 2 may be subjected to a plating treatment such as a Ni plating treatment, a passivation treatment such as a chromate treatment, a nitriding treatment, or the like.

Furthermore, a shape of the substrate (base) 2 is not particularly limited to a plate shape, as long as it has a shape with a surface which can support the bonding film 3. In other words, examples of the shape of the substrate 2 include a massive shape (blocky shape), a stick shape, and the like.

In this embodiment, since the substrate 2 has a plate shape, it can easily bend. Therefore, the substrate 2 becomes sufficiently bendable according to a shape of an opposite substrate 4. This makes it possible to improve bonding strength between the base member 1 having such a substrate 2 and the opposite substrate 4.

Further, it is also possible to improve bonding strength between the substrate 2 and the bonding film 3 in the base member 1. In addition, since the substrate 2 can easily bend, stress which would be generated in a bonding surface therebetween can be reduced to some extent.

In this case, an average thickness of the substrate 2 is not particularly limited to a specific value, but is preferably in the range of about 0.01 to 10 mm, and more preferably in the range of about 0.1 to 3 mm. Further, it is preferred that the opposite substrate 4 has an average thickness equal to that of the above substrate 2.

On the other hand, the bonding film 3 lies between the substrate 2 and the opposite substrate 4 described above, and can join them together.

As shown in FIGS. 3 and 4, the bonding film 3 contains an Si-skeleton 301 having siloxane bonds (Si—O) 302, of which constituent atoms are bonded to each other, and elimination groups 303 bonding to silicon atoms of the Si-skeleton 301.

The feature of the base member 1 of the present invention mainly resides on the characteristics of the bonding film 3 which is resulted from the structure thereof. In this regard, it is to be noted that the bonding film 3 will be described later in detail.

Prior to forming the bonding film 3, it is preferred that at least a predetermined region of the substrate 2 where the bonding film 3 is to be formed has been, in advance, subjected to a surface treatment for improving bonding strength between the substrate 2 and the bonding film 3, depending on the constituent material of the substrate 2.

Examples of such a surface treatment include: a physical surface treatment such as a sputtering treatment or a blast treatment; a chemical surface treatment such as a plasma treatment performed using oxygen plasma and nitrogen plasma, a corona discharge treatment, an etching treatment, an electron beam irradiation treatment, an ultraviolet ray irradiation treatment or an ozone exposure treatment; a treatment performed by combining two or more kinds of these surface treatments; and the like.

By subjecting the predetermined region of the substrate 2 where the bonding film 3 is to be formed to such a treatment, it is possible to clean and activate the predetermined region. This makes it possible to improve the bonding strength between the bonding film 3 and the substrate 2.

Among these surface treatments, use of the plasma treatment makes it possible to particularly optimize the surface (the predetermined region) of the substrate 2 so as to be able to form the bonding film 3 thereon.

In this regard, it is to be noted that in the case where the surface of the substrate 2 to be subjected to the surface treatment is formed of a resin material (a polymeric material), the corona discharge treatment, the nitrogen plasma treatment and the like are particularly preferably used.

Depending on the constituent material of the substrate 2, the bonding strength of the bonding film 3 against the substrate 2 becomes sufficiently high even if the surface of the substrate 2 is not subjected to the surface treatment described above.

Examples of the constituent material of the substrate 2 with which such an effect is obtained include materials containing the various kinds of metal-based materials, the various kinds of silicon-based materials, the various kinds of glass-based materials and the like as a major component thereof.

The surface of the substrate 2 formed of such a material is covered with an oxide film. In the oxide film, hydroxyl groups having relatively high activity exist in a surface thereof. Therefore, in a case where the substrate 2 formed of such a material is used, it is possible to improve bonding strength of the bonding film 3 against the substrate 2 without subjecting the surface thereof to the surface treatment described above.

In this case, the entire of the substrate 2 may not be formed of the above materials, as long as at least the region of the surface of the substrate 2 where the bonding film 3 is to be formed is formed of the above materials.

Further, instead of the surface treatment, an intermediate layer have preferably been, in advance, provided on at least the predetermined region of the substrate 2 where the bonding film 3 is to be formed. This intermediate layer may have any function.

Such a function is not particularly limited to a specific kind. Examples of the function include: a function of improving binding strength of the substrate 2 to the bonding film 3; a cushion property (that is, a buffering function); a function of reducing stress concentration and the like.

By using such a base member in which the substrate 2 and the bonding film 3 are bonded together through the intermediate layer, a bonded body having a high reliability can be obtained.

A constituent material of the intermediate layer include: a metal-based material such as aluminum or titanium; an oxide-based material such as metal oxide or silicon oxide; a nitride-based material such as metal nitride or silicon nitride; a carbon-based material such as graphite or diamond-like carbon; a self-organization film material such as a silane coupling agent, a thiol-based compound, metal alkoxide or metal halide; a resin-based material such as a resin-based adhesive agent, a resin filming material, a resin coating material, various rubbers or various elastomer; and the like, and one or more of which may be used independently or in combination.

Among intermediate layers composed of these various materials, use of the intermediate layer composed of the oxide-based material makes it possible to further improve bonding strength between the substrate 2 and the bonding film 3 through the intermediate layer.

[2] Next, energy is applied to a surface 35 of the bonding film 3 of the base member 1.

In a case where the energy is applied to the bonding film 3, the elimination groups 303 are removed from the silicon atoms of Si-skeleton 301 included in the bonding film 3. After the elimination groups 303 have been removed, active hands 304 are generated on the surface and in the vicinity of the surface 35 and the inside of the bonding film 3.

As a result, the surface 35 of the bonding film 3 develops the bonding property with respect to the opposite substrate 4, that is, the bonding film 3 is activated. The base member 1 having such a state can be firmly bonded to the opposite substrate 4 on the basis of chemical bonds to be produced using the active hands 304.

The energy may be applied to the bonding film 3 by any method. Examples of the method include: a method in which an energy beam is irradiated on the bonding film 3; a method in which the bonding film 3 is heated; a method in which a compressive force (physical energy) is applied to the bonding film 3; a method in which the bonding film 3 is exposed to plasma (that is, plasma energy is applied to the bonding film 3); a method in which the bonding film 3 is exposed to an ozone gas (that is, chemical energy is applied to the bonding film 3); and the like.

Among these methods, in this embodiment, it is particularly preferred that the method in which the energy beam is irradiated on the bonding film 3 is used as the method in which the energy is applied to the bonding film 3. Since such a method can efficiently apply the energy to the bonding film 3 relatively easily, the method is suitably used as the method of applying the energy.

Examples of the energy beam include: a light such as an ultraviolet ray or a laser light; a particle beam such as a X ray, a y ray, an electron beam or an ion beam; and combinations of two or more kinds of these energy beams.

Among these energy beams, it is particularly preferred that the ultraviolet ray having a wavelength of about 150 to 300 nm is used (see FIG. 1B). Use of the ultraviolet ray having such a wavelength makes it possible to optimize an amount of the energy to be applied to the bonding film 3.

As a result, it is possible to selectively cut bonds between the elimination groups 303 and the silicon atoms of the Si-skeleton, while preventing the Si-skeleton included in the bonding film 3 from being broken more than necessary. This makes it possible for the bonding film 3 to develop a bonding property, while preventing characteristics thereof such as mechanical characteristics or chemical characteristics from being reduced.

Further, the use of the ultraviolet ray makes it possible to process a wide area of the surface 35 of the bonding film 3 without unevenness in a short period of time. Therefore, the removal (eliminating) of the elimination groups 303 can be efficiently performed.

Moreover, such an ultraviolet ray has, for example, an advantage that it can be generated by simple equipment such as an UV lamp. In this regard, it is to be noted that the wavelength of the ultraviolet ray is more preferably in the range of about 160 to 200 nm.

In the case where the UV lamp is used, power of the UV lamp is preferably in the range about of 1 mW/cm² to 1 W/cm², and more preferably in the range of about 5 to 50 mW/cm², although being different depending on an area of the surface 35 of the bonding film 3. In this case, a distance between the UV lamp and the bonding film 3 is preferably in the range of about 3 to 3000 mm, and more preferably in the range of about 10 to 1000 mm.

Further, a time for irradiating the ultraviolet ray is preferably set to an enough time for removing the elimination groups 303 from the vicinity of the surface 35 of the bonding film 3, i.e., an enough time not to remove a large number of the elimination groups 303 inside the bonding film 3.

Specifically, the time is preferably in the range of about 0.5 to 30 minutes, and more preferably in the range of about 1 to 10 minutes, although being slightly different depending on an amount of the ultraviolet ray, the constituent material of the bonding film 3, and the like. The ultraviolet ray may be irradiated temporally continuously or intermittently (in a pulse-like manner).

On the other hand, examples of the laser light include an excimer laser (femto-second laser), an Nd-YAG laser, an Ar laser, a CO₂ laser, a He—Ne laser, and the like.

Further, the irradiation of the energy beam on the bonding film 3 may be performed in any atmosphere. Specifically, examples of the atmosphere include: an oxidizing gas atmospheres such as atmosphere (air) or an oxygen gas; a reducing gas atmospheres such as a hydrogen gas; an inert gas atmospheres such as a nitrogen gas or an argon gas; a decompressed (vacuum) atmospheres obtained by decompressing these atmospheres; and the like.

Among these atmospheres, the irradiation is particularly preferably performed in the atmosphere. As a result, it becomes unnecessary to spend labor hour and cost for controlling the atmosphere. This makes it possible to easily perform (carry out) the irradiation of the energy beam.

In this way, according to the method of irradiating the energy beam, the energy can be easily applied to the vicinity of the surface 35 of the bonding film 3 selectively. Therefore, it is possible to prevent, for example, alteration and deterioration of the substrate 2 and the bonding film 3, i.e., alteration and deterioration of the base member 1 due to the application of the energy.

Further, according to the method of irradiating the energy beam, a degree of the energy to be applied can be accurately and easily controlled. Therefore, it is possible to adjust the number of the elimination groups 303 to be removed from the bonding film 3. By adjusting the number of the elimination groups 303 to be removed from the bonding film 3 in this way, it is possible to easily control bonding strength between the base member 1 and the opposite substrate 4.

In other words, by increasing the number of the elimination groups 303 to be removed, since a large number of active hands 304 are generated in the vicinity of the surface 35 and the inside of the bonding film 3, it is possible to further improve a bonding property developed in the bonding film 3.

On the other hand, by reducing the number of the elimination groups 303 to be removed, it is possible to reduce the number of the active hands 304 generated in the vicinity of the surface 35 and the inside of the bonding film 3 and suppress a bonding property developed in the bonding film 3.

In order to adjust magnitude of the applied energy, for example, conditions such as the kind of the energy beam, the power of the energy beam, and the irradiation time of the energy beam only have to be controlled.

Moreover, according to the method of irradiating the energy beam, since large energy can be applied to the bonding film 3 in a short period of time, it is possible to more efficiently apply energy onto the bonding film 3.

As shown in FIG. 3, the bonding film 3 before the application of the energy has the Si-skeleton 301 and the elimination groups 303 in the vicinity of the surface 35 thereof. In a case where the energy is applied to such a bonding film 3, the elimination groups 303 (methyl groups in FIG. 3) are removed from the silicon atoms of the Si-skeleton 301.

At this time, as shown in FIG. 4, the active hands 304 are generated on the surface 35 of the bonding film 3 to activate the surface 35 thereof. As a result, a bonding property is developed on the surface 35 of the bonding film 3.

Here, in this specification, a state that the bonding film 3 is “activated” means: a state that the elimination groups 303 existing on the surface 35 and in the inside of the bonding film 3 are removed as described above, and bonding hands (hereinafter, referred to as simply “non-bonding hands” or “dangling bonds”) not be end-capped are generated in the silicon atoms of Si-skeleton 301; a state that the non-bonding hands are end-capped by hydroxyl groups (OH groups); and a state that the dangling bonds and the hydroxyl groups coexist on the surface 35 of the bonding film 3.

Therefore, as shown in FIG. 4, the active hands 304 refer to the non-bonding hands (dangling bonds) and/or ones that the non-bonding hands are end-capped by the hydroxyl groups. If such active hands 304 exist on the surface 35 of the bonding film 3, it is possible to particularly firmly bond the base member 1 to the opposite substrate 4 through the bonding film 3.

In this regard, the latter state (that is, the state that the non-bonding hands are end-capped by the hydroxyl groups) is easily generated, because, for example, when the energy beam is merely irradiated on the bonding film 3 in an atmosphere, water molecules contained therein bond to the non-bonding hands.

In this embodiment, before the base member 1 and the opposite substrate 4 are laminated together, the energy has been applied to the bonding film 3 of the base member 1 in advance. However, such energy may be applied at a time when the base member 1 and the opposite substrate 4 are laminated together or after the base member 1 and the opposite substrate 4 have been laminated together. Such a case will be described in a second embodiment described below.

[3] The opposite substrate (the object) 4 is prepared. As shown in FIG. 1C, the base member 1 makes close contact with the opposite substrate 4 through the bonding film 3 thereof. As a result, the base member 1 is bonded to the opposite substrate 4, to thereby obtain a bonded body 5 shown in FIG. 2D.

In the bonded body 5 obtained in this way, the base member 1 and the opposite substrate 4 are bonded together by firm chemical bonds formed in a short period of time such as a covalent bond, unlike bond (adhesion) mainly based on a physical bond such as an anchor effect by using the conventional adhesive. Therefore, it is possible to obtain a bonded body 5 in a short period of time, and to prevent occurrence of peeling, bonding unevenness and the like in the bonded body 5.

Further, according to such a method of manufacturing the bonded body 5 using the base member 1, a heat treatment at a high temperature (e.g., a temperature equal to or higher than 700° C.) is unnecessary unlike the conventional solid bonding method. Therefore, the substrate 2 and the opposite substrate 4 each formed of a material having low heat resistance can also be used for bonding them.

In addition, the substrate 2 and the opposite substrate 4 are bonded together through the bonding film 3. Therefore, there is also an advantage that each of the constituent materials of the substrate 2 and the opposite substrate 4 is not limited to a specific kind.

For these reasons, according to the present invention, it is possible to expand selections of the constituent materials of the substrate 2 and the opposite substrate 4.

Moreover, in the conventional solid bonding method, the substrate 2 and the opposite substrate 4 are bonded together without intervention of a bonding layer. Therefore, in the case where the substrate 2 and the opposite substrate 4 exhibit a large difference in their thermal expansion coefficients, stress based on the difference tends to concentrate on a bonding interface therebetween. It is likely that peeling of the bonding interface and the like occur.

However, since the bonded body (the bonded body of the present invention) 5 has the bonding film 3, the concentration of the stress which would be generated is reduced due to the presence thereof. This makes it possible to accurately suppress or prevent occurrence of peeling in the bonded body 5.

Further, in this embodiment, the bonding film 3 is provided on only one of the substrate 2 and the opposite substrate 4 which are to be bonded together (in this embodiment, the substrate 2). Therefore, in the case where the bonding film 3 is formed on the substrate 2 using a plasma treatment, the substrate 2 is exposed to plasma for a relatively long period of time. On the other hand, in this embodiment, the opposite substrate 4 is not exposed to the plasma at all.

For reason, even if an opposite substrate 4 having low durability against the plasma is used, the base member 1 and the opposite substrate 4 can be firmly bonded together according to the bonding method of this embodiment. Therefore, there is a merit that the constituent materials of the opposite substrate 4 can be selected from expanded materials without considering durability thereof against the plasma.

Like the substrate 2, the opposite substrate 4 to be bonded to the base member 1 may be formed of any material. Specifically, the opposite substrate 4 can be formed of the same material as that constituting the substrate 2.

Further, like the substrate 2, a shape of the opposite substrate 4 is not particularly limited to a specific type, as long as it has a shape with a surface which can bond to the bonding film 3. Examples of the shape of the opposite substrate 4 include a plate shape (a film shape), a massive shape (a blocky shape), a stick shape, and the like.

The constituent material of the opposite substrate 4 may be different from or the same as that of the substrate 2.

Further, it is preferred that the substrate 2 and the opposite substrate 4 have substantially equal thermal expansion coefficients with each other.

In the case where the substrate 2 and the opposite substrate 4 have the substantially equal thermal expansion coefficients with each other, when the base member 1 and the opposite substrate 4 are bonded together, stress due to thermal expansion is less easily generated on a bonding interface therebetween. As a result, it is possible to reliably prevent occurrence of deficiencies such as peeling in the bonded body 5 finally obtained.

Further, in the case where the substrate 2 and the opposite substrate 4 have a difference in their thermal expansion coefficients with each other, it is preferred that conditions for bonding between the base member 1 and the opposite substrate 4 are optimized as follows. This makes it possible to firmly bond the base member 1 and the opposite substrate 4 together with high dimensional accuracy.

In other words, in the case where the substrate 2 and the opposite substrate 4 have the difference in their thermal expansion coefficients with each other, it is preferred that the base member 1 and the opposite substrate 4 are bonded together at as low temperature as possible. If they are bonded together at the low temperature, it is possible to further reduce thermal stress which would be generated on the bonding interface therebetween.

Specifically, the base member 1 and the opposite substrate 4 are bonded together in a state that each of the substrate 2 and the opposite substrate 4 is heated preferably at a temperature of about 25 to 50° C., and more preferably at a temperature of about 25 to 40° C., although being different depending on the difference between the thermal expansion coefficients thereof.

In such a temperature range, even if the difference between the thermal expansion coefficients of the substrate 2 and the opposite substrate 4 is rather large, it is possible to sufficiently reduce thermal stress which would be generated on the bonding interface between the base member 1 (the bonding film 3) and the opposite substrate 4. As a result, it is possible to reliably suppress or prevent occurrence of warp, peeling or the like in the bonded body 5.

Especially, in the case where the difference between the thermal expansion coefficients of the substrate 2 and the opposite substrate 4 is equal to or larger than 5×10⁻⁵/K, it is particularly recommended that the base member 1 and the opposite substrate 4 are bonded together at a low temperature as much as possible as described above. Moreover, it is preferred that the substrate 2 and the opposite substrate 4 have a difference in their rigidities. This makes it possible to more firmly bond the base member 1 and the opposite substrate 4 together.

Further, it is preferred that at least one substrate of the substrate 2 and the opposite substrate 4 is composed of a resin material. The substrate composed of the resin material can be easily deformed due to plasticity of the resin material itself.

Therefore, it is possible to reduce stress which would be generated on the bonding surface between the substrate 2 and the opposite substrate 4 (e.g., stress due to thermal expansion thereof). As a result, breaking of the bonding surface becomes hard. This makes it possible to obtain a bonded body 5 having high bonding strength between the base member 1 and the opposite substrate 4.

Before the base member 1 and the opposite substrate 4 are bonded together, it is preferred that a predetermined region of the above mentioned opposite substrate 4 to which the base member 1 is to be bonded has been, in advance, subjected to the same surface treatment as employed in the substrate 2, depending on the constituent material of the opposite substrate 4.

In this case, the surface treatment is a treatment for improving bonding strength between the base member 1 and the opposite substrate 4. By subjecting the region of the opposite substrate 4 to the surface treatment, it is possible to further improve the bonding strength between the base member 1 and the opposite substrate 4.

In this regard, it is to be noted that the opposite substrate 4 can be subjected to the same surface treatment as the above mentioned surface treatment to which the substrate 2 is subjected.

Depending on the constituent material of the opposite substrate 4, the bonding strength between the base member 1 and the opposite substrate 4 becomes sufficiently high even if the surface of the opposite substrate 4 is not subjected to the surface treatment described above.

Examples of the constituent material of the opposite substrate 4 with which such an effect is obtained include the same material as that constituting the substrate 2, that is, the various kinds of metal-based materials, the various kinds of silicon-based materials, the various kinds of glass-based materials and the like.

Furthermore, if the region of the surface of the opposite substrate 4, to which the base member 1 is to be bonded, has the following groups and substances, the bonding strength between the base member 1 and the opposite substrate 4 can become sufficiently high even if the region is not subjected to the surface treatment described above.

Examples of such groups and substances include at least one group or substance selected from the group comprising a functional group such as a hydroxyl group, a thiol group, a carboxyl group, an amino group, a nitro group or an imidazole group, a radical, an open circular molecule, an unsaturated bond such as a double bond or a triple bond, a halogen atom such as a F atom, a Cl atom, a Br atom or an I atom, and peroxide.

In the case where the surface of the opposite substrate 4 has such groups or substances, it is possible to further improve the bonding strength between the bonding film 3 of the base member 1 and the opposite substrate 4.

By appropriately performing one selected from various surface treatment described above, the surface having such groups and substances can be obtained. This makes it possible to obtain an opposite substrate 4 that can be particularly firmly bonded to the base member 1.

Instead of the surface treatment, an intermediate layer having a function of improving bonding strength between the opposite substrate 4 and the base member 1 (the bonding film 3) may have been, in advance, provided on the region of the surface of the opposite substrate 4 to which the base member 1 is to be bonded.

In this case, the base member 1 and the opposite substrate 4 are bonded together through such an intermediate layer of the opposite substrate 4, which makes it possible to obtain a bonded body 5 having higher bonding strength between the base member 1 and the opposite substrate 4.

As a constituent material of such a intermediate layer, the same material as the constituent material of the above intermediate layer to be provided on the substrate 2 can be used.

Here, a description will be made on a mechanism that the base member and the opposite substrate 4 are bonded together in this process. Hereinafter, the description will be representatively offered regarding a case that the hydroxyl groups are exposed in the region of the surface of the opposite substrate 4 to which the base member 1 is to be bonded.

In this process, when the base member 1 and the opposite substrate 4 are laminated together so that the bonding film 3 makes contact with the opposite substrate 4, the hydroxyl groups existing on the surface 35 of the bonding film 3 and the hydroxyl groups existing in the region of the surface of the opposite substrate 4 are attracted together, as a result of which hydrogen bonds are generated between the above adjacent hydroxyl groups. It is conceived that the generation of the hydrogen bonds makes it possible to bond the base member 1 and the opposite substrate 4 together.

Depending on conditions such as a temperature and the like, the hydroxyl groups bonded together through the hydrogen bonds are dehydrated and condensed, so that the hydroxyl groups and/or water molecules are removed from the bonding surface (the contact surface) between the base member 1 and the opposite substrate 4. As a result, two bonding hands, to which the hydroxyl group had been bonded, are bonded together via oxygen atoms. In this way, it is conceived that the base member 1 and the opposite substrate 4 are firmly bonded together.

In this regard, an activated state that the surface 35 of the bonding film 3 is activated in the step [2] is reduced with time. Therefore, it is preferred that this step [3] is started as early as possible after the step [2]. Specifically, this step [3] is preferably started within 60 minutes, and more preferably started within 5 minutes after the step [2].

If the step [3] is started within such a time, since the surface 35 of the bonding film 3 maintains a sufficient activated state, when the base member 1 is bonded to the opposite substrate 4 through the bonding film 3 thereof, they can be bonded together with sufficient high bonding strength therebetween.

In other words, the bonding film 3 before being activated is a film containing the Si-skeleton 301, and therefore it has relatively high chemical stability and excellent weather resistance. For this reason, the bonding film 3 before being activated can be stably stored for a long period of time. Therefore, the base member 1 having such a bonding film 3 may be used as follows.

Namely, first, a large number of the base members 1 have been manufactured or purchased, and stored in advance. Then just before the base member 1 makes close contact with the opposite substrate 4 in this step, the energy is applied to only a necessary number of the base members 1 as described in the step [2]. This use is preferable because the bonded bodies 5 are manufactured effectively.

In the manner described above, it is possible to obtain a bonded body (the bonded body of the present invention) 5 shown in FIG. 2D.

In FIG. 2D, the opposite substrate 4 is bonded (attached) to the base member 1 so as to cover the entire surface 35 of the bonding film 3 thereof. However, a relative position of the base member 1 with respect to the opposite substrate 4 may be shifted. In other words, the opposite substrate 4 may be bonded to the base member 1 so as to extend beyond the bonding film 3 thereof.

In the bonded body 5 obtained in this way, bonding strength between the substrate 2 (the base member 1) and the opposite substrate 4 is preferably equal to or larger than 5 MPa (50 kgf/cm²), and more preferably equal to or larger than 10 MPa (100 kgf/cm²). Therefore, peeling of the bonded body 5 having such bonding strength therebetween can be sufficiently prevented.

As described later, in the case where a droplet ejection head is formed using the bonded body 5, it is possible to obtain a droplet ejection head having excellent durability. Further, use of the base member 1 of the present invention makes it possible to efficiently manufacture the bonded body 5 in which the substrate 2 (the base member 1) and the opposite substrate 4 are bonded together through the bonding film 3 by the above large bonding strength therebetween.

In the conventional solid bonding method such as a bonding method of directly bonding silicon substrates, even if surfaces of the silicon substrates to be bonded together are activated, an activated state of each surface can be maintained only for an extremely short period of time (e.g., about several to several tens seconds) in an atmosphere. Therefore, there is a problem in that, after each surface is activated, for example, a time for bonding the two silicon substrates together cannot be sufficiently secured.

On the other hand, according to the present invention, since such a bonding method is performed by using the bonding film 3 having the Si-skeleton 301, the activated state of the bonding film 3 can be maintained over a relatively long period of time. Therefore, a time for bonding the base member 1 and the opposite substrate 4 can be sufficiently secured, which makes it possible to improve efficiency of bonding them together.

Just when the bonded body 5 is obtained or after the bonded body 5 has been obtained, if necessary, at least one step (a step of improving bonding strength between the base member 1 and the opposite substrate 4) among three steps (steps [4A], [4B] and [4C]) described below may be applied to the bonded body 5 (a pre-bonded body in which the base member 1 and the opposite substrate 4 are laminated together). This makes it possible to further improve the bonding strength between the base member 1 and the opposite substrate 4.

[4A] In this step, as shown in FIG. 2E, the obtained bonded body 5 is pressed in a direction in which the substrate 2 and the opposite substrate 4 come close to each other.

As a result, surfaces of the bonding film 3 come closer to the surface of the substrate 2 and the surface of the opposite substrate 4. It is possible to further improve the bonding strength between the members in the bonded body 5 (e.g., between the substrate 2 and the bonding film 3, between the bonding film 3 and the opposite substrate 4).

Further, by pressing the bonded body 5, spaces remaining in the boding interfaces (the contact interfaces) in the bonded body 5 can be crashed to further increase a bonding area (a contact area) thereof. This makes it possible to further improve the bonding strength between the members in the bonded body 5.

At this time, it is preferred that a pressure in pressing the bonded body 5 is as high as possible within a range in which the bonded body 5 is not damaged. This makes it possible to improve the bonding strength between the members in the bonded body 5 relative to a degree of this pressure.

In this regard, it is to be noted that this pressure can be appropriately adjusted, depending on the constituent materials and thicknesses of the substrate 2 and opposite substrate 4, conditions of a bonding apparatus, and the like.

Specifically, the pressure is preferably in the range of about 0.2 to 10 MPa, and more preferably in the range of about 1 to 5 MPa, although being slightly different depending on the constituent materials and thicknesses of the substrate 2 and opposite substrate 4, and the like.

By setting the pressure to the above range, it is possible to reliably improve the bonding strength between the members in the bonded body 5. Further, although the pressure may exceed the above upper limit value, there is a fear that damages and the like occur in the substrate 2 and the opposite substrate 4, depending on the constituent materials thereof.

A time for pressing the bonded body 5 is not particularly limited to a specific value, but is preferably in the range of about 10 seconds to 30 minutes. The pressing time can be appropriately changed, depending on the pressure for pressing the bonded body 5. Specifically, in the case where the pressure in pressing the bonded body 5 is higher, it is possible to improve the bonding strength between the members in the bonded body 5 even if the pressing time becomes short.

[4B] In this step, as shown in FIG. 2E, the obtained bonded body 5 is heated.

This makes it possible to further improve the bonding strength between the members in the bonded body 5. A temperature in heating the bonded body 5 is not particularly limited to a specific value, as long as the temperature is higher than room temperature and lower than a heat resistant temperature of the bonded body 5.

Specifically, the temperature is preferably in the range of about 25 to 200° C., and more preferably in the range of about 50 to 100° C. If the bonded body 5 is heated at the temperature of the above range, it is possible to reliably improve the bonding strength between the members in the bonded body 5 while reliably preventing them from being thermally altered and deteriorated.

Further, a heating time is not particularly limited to a specific value, but is preferably in the range of about 1 to 30 minutes.

In the case where both steps [4A] and [4B] are performed, the steps are preferably performed simultaneously. In other words, as shown in FIG. 2E, the bonded body 5 is preferably heated while being pressed. By doing so, an effect by pressing and an effect by heating are exhibited synergistically. It is possible to particularly improve the bonding strength between the members in the bonded body 5.

[4C] In this step, as shown in FIG. 2F, an ultraviolet ray is irradiated on the obtained bonded body 5.

This makes it possible to increase the number of chemical bonds formed between the members in the bonded body 5 (e.g., between the substrate 2 and the bonding film 3, between the bonding film 3 and the opposite substrate 4). As a result, it is possible to improve the bonding strength between the members in the bonded body 5.

Conditions of the ultraviolet ray irradiated at this time can be the same as those of the ultraviolet ray irradiated in the step [2] described above.

Further, in the case where this step [4C] is performed, one of the substrate 2 and the opposite substrate 4 needs to have translucency. It is possible to reliably irradiate the ultraviolet ray on the bonding film 3 by irradiating it from the side of the substrate having translucency.

Through the steps described above, it is possible to easily improve the bonding strength between the members in the bonded body 5 (especially, between the bonding film 3 and the opposite substrate 4), and, eventually, to further improve the bonding strength between the base member 1 and the opposite substrate 4.

Here, as described above, the base member 1 of the present invention has characteristics in the structure of the bonding film 3. Hereinafter, the bonding film 3 will be described in detail.

As shown in FIGS. 3 and 4, the bonding film 3 is formed by using a plasma polymerization (plasma polymerization method). The bonding film 3 contains the Si-skeleton 301 having the siloxane bonds (Si—O) 302, of which constituent atoms are bonded to each other, and the elimination groups 303 bonding to the silicon atoms of the Si-skeleton 301.

Such a bonding film 3 is a firm film which is difficult to be deformed due to the Si-skeleton 301 having the siloxane bonds (Si—O) 302, of which constituent atoms are bonded to each other.

It is considered that this is because it is difficult to generate defects such as dislocation and shift of the bonding film 3 in a crystal grain boundary due to the low crystallinity degree of the Si-skeleton 301. Therefore, the bonding strength, chemical resistance, and dimensional accuracy of the bonding film 3 in itself become high. As a result, in the finally obtained bonded body 5, the bonding strength, chemical resistance, and dimensional accuracy of the bonding body 5 also become high.

In a case where the energy is applied to such a bonding film 3, the elimination groups 303 are removed from the silicon atoms of the Si-skeleton 301 to generate the active hands 304 in the vicinity of the surface 35 and the inside of the bonding film 3 as shown in FIG. 4. As a result, the surface 35 of the bonding film 3 develops a bonding property.

In the case where the bonding property is developed on the surface 35 of the bonding film 3, the base member 1 can be firmly and efficiently bonded to the opposite substrate 4 with high dimensional accuracy through the bonding film 3 thereof.

Furthermore, such a bonding film 3 is in the form of a solid having no fluidity. Therefore, thickness and shape of a bonding layer (the bonding film 3) are hardly changed as compared to a conventional adhesive layer formed of an aquiform or muciform (semisolid) adhesive having fluidity.

Therefore, dimensional accuracy of the bonded body 5 obtained by bonding the base member 1 and the opposite substrate 4 together becomes extremely high as compared to a conventional bonded body obtained using the adhesive layer (the adhesive). In addition, since it is not necessary to wait until the adhesive is hardened, it is possible to firmly bond the base member 1 to the opposite substrate 4 in a short period of time as compared to the conventional bonded body.

A sum of a content of the silicon atoms and a content of oxygen atoms in the whole atoms (constituent atoms) constituting such a bonding film 3 other than the hydrogen atoms is preferably in the range of about 10 to 90 atom % and more preferably in the range of about 20 to 80 atom %.

Such a sum of the contents makes it possible to form a firm network bond between the silicon atoms and the oxygen atoms, thereby enabling to obtain the firm bonding film 3 in itself. Further, it is possible to obtain a bonding film 3 having high bonding strength with respect to the substrate 2 and the opposite substrate 4.

An abundance ratio of the silicon atoms and the oxygen atoms contained in the bonding film 3 is preferably in the range of about 3:7 to 7:3 and more preferably in the range of about 4:6 to 6:4. By setting the abundance ratio of the silicon atoms and the oxygen atoms to a value within the above range, the bonding film 3 has high stability and can firmly bond the substrate 2 and the opposite substrate 4.

In this regard, a crystallinity degree of the Si-skeleton 301 included in the bonding film 3 is preferably equal to or lower than 45%, and more preferably equal to or lower than 40%. This makes it possible to bond the constituent atoms of the Si-skeleton 301. Therefore, characteristics of the Si-skeleton 301 described above are conspicuously exhibited, and therefore the bonding film 3 has superior dimensional accuracy and bonding property.

It is preferred that the bonding film 3 contains Si—H bonds in a chemical structure thereof. The Si—H bonds are formed in polymers obtained by polymerizing silane with a plasma polymerization method. At this time, it is considered that the Si—H bonds prevent siloxane bonds from being regularly formed.

Therefore, the siloxane bonds are formed so as to avoid the Si—H bonds, which reduce regularity of the constituent atoms of the Si-skeleton 301. According to such a plasma polymerization method, it is possible to efficiently form the Si-skeleton 301 having a low crystallinity degree.

The larger an amount of the Si—H bonds contained in the bonding film 3 is, the smaller the low crystallinity degree of the Si-skeleton 301 is not. The bonding film 3 is subjected to an infrared absorption measurement by an infrared absorption measurement apparatus to obtain an infrared absorption spectrum.

Then, in a case where an intensity of a peak derived from a siloxane bond in the infrared absorption spectrum is defined as “1”, an intensity of a peak derived from a Si—H bond in the infrared absorption spectrum is preferably in the range of about 0.001 to 0.2, more preferably in the range of about 0.002 to 0.05 and even more preferably in the range of about 0.005 to 0.02.

By setting the intensity of the peak derived from the Si—H bond with respect to the intensity derived from the siloxane bond to a value within the above range, the constituent atoms of the Si-skeleton 301 included in the bonding film 3 are more bonded together in comparison.

If the intensity of the peak derived from the Si—H bond with respect to the intensity derived from the siloxane bond falls within the above range, the bonding film 3 has superior bonding strength, chemical resistance and dimensional accuracy.

As described above, the elimination groups 303 bonded to the silicon atoms contained in the Si-skeleton 301 are eliminated from the silicon atoms contained in the Si-skeleton 301 so that the active hands 304 are generated at portions of the Si-skeleton 301 where the elimination groups 303 have been existed.

In this way, the elimination groups 303 are relatively easily and uniformly eliminated from the silicon atoms thereof by applying energy to the bonding film 3. On the other hand, the elimination groups 303 are reliably bonded to the silicon atoms included in the Si-skeleton 301 so as not to be eliminated therefrom when no energy is applied to the bonding film 3.

From this viewpoint, the elimination groups 303 are preferably constituted of at least one selected from the group consisting of a hydrogen atom, a boron atom, a carbon atom, a nitrogen atom, an oxygen atom, a phosphorus atom, a sulfur atom, a halogen-based atom and an atom group in which these atoms are bonded to the constituent atoms of the Si-skeleton 301.

Such elimination groups 303 have relatively superior selectivity in bonding and eliminating to and from the silicon atoms by applying energy to the bonding film 3. Therefore, the elimination groups 303 satisfy the needs as described above so that the base member 1 has high bonding property.

Examples of the atom group in which the atoms described above are bonded to the constituent atoms of the Si-skeleton 301 include an alkyl group such as a methyl group and an ethyl group, an alkenyl group such as a vinyl group and an allyl group, an aldehyde group, a ketone group, a carboxyl group, an amino group, an amide group, a nitro group, a halogenated alkyl group, a mercapt group, a sulfone group, a cyano group, an isocyanate group and the like.

Among these groups mentioned above, the elimination groups 303 are preferably the alkyl group. Since the alkyl group has chemically high stability, the bonding film 3 containing the alkyl group as the elimination groups 303 exhibits superior weather resistance and chemical resistance.

In the case where the elimination groups 303 are the methyl group (—CH₃), an amount of the methyl group is obtained from an intensity of a peak derived from the methyl group in an infrared absorption spectrum which is obtained by subjecting the bonding film 3 to an infrared absorption measurement by an infrared absorption measurement apparatus as follows.

In the infrared absorption spectrum of the bonding film 3, in a case where an intensity of a peak derived from a siloxane bond is defined as “1”, the intensity of the peak derived from the methyl group is preferably in the range of about 0.05 to 0.45, more preferably in the range of about 0.1 to 0.4 and even more preferably in the range of about 0.2 to 0.3. By setting the intensity of the peak derived from the methyl group with respect to the peak derived from the siloxane bond to a value within the above range, it is possible to appropriately form the siloxane bonds.

Further, since a necessary and sufficient number of the active hands 304 are formed in silicon atoms of the Si-skeleton 301 included in the bonding film 3, bonding property is developed in the bonding film 3. Furthermore, sufficient weather property and chemical property are given to the bonding film 3 due to bonding of the methyl group to the silicon atoms.

Examples of a constitute material of the bonding film 3 having such features include a polymer containing siloxane bonds such as polyorganosiloxane and the like. In the case where the bonding film 3 is constituted of polyorganosiloxane, the bonding film 3 has superior mechanical property in itself.

Further, the bonding film 3 also has superior bonding property to various materials. Therefore, the bonding film 3 constituted of polyorganosiloxane can firmly bond to the substrate 2 and the opposite substrate 4, so that the substrate 2 can be firmly bonded to the opposite substrate 4 through the bonding film 3.

Polyorganosiloxane normally has repellency (non-bonding property). However, organic groups contained in polyorganosiloxane can be easily eliminated by applying energy to polyorganosiloxane, so that polyorganosiloxane has hydrophilic property and develops bonding property. As a result, use of polyorganosiloxane makes it possible to easily and reliably control non-bonding property and bonding property.

In this regard, it is to be noted that the repellency (non-bonding property) is an effect due to alkyl groups contained in polyorganosiloxane. Therefore, the bonding film 3 constituted of polyorganosiloxane has the bonding property in regions of the surface 35 thereof to which energy is applied. In addition, it is possible to obtain actions and effects derived from the alkyl groups described above in parts other than the surface 35.

Therefore, the bonding film 3 exhibits superior weather resistance and chemical resistance. For example, in a case where substrates are bonded together so as to be exposed to chemicals for a long period of time, such a bonding film 3 can be effectively used.

As a result, when a head included in an industrial ink jet printer using an organic ink which easily corrades resin materials is produced, the head can have superior durability and high reliability by using the base member 1 which is provided with the bonding film 3 constituted of polyorganosiloxane.

Among polyorganosiloxane, the bonding film 3 is preferably constituted of a polymer of octamethyltrisiloxane as a main component thereof. The bonding film 3 constituted of the polymer of octamethyltrisiloxane as a main component thereof exhibits particularly superior bonding property. Therefore, such a bonding film 3 is preferably used in the base member 1 according to the present invention.

Further, octamethyltrisiloxane is a liquid form at a normal temperature and has appropriate viscosity. Therefore, octamethyltrisiloxane has an advantage in that it can be easily handled.

Further, an average thickness of the bonding film 3 is preferably in the range of about 1 to 1000 nm, and more preferably in the range of about 2 to 800 nm. By setting the average thickness of the bonding film 3 to the above range, it is possible to prevent dimensional accuracy of the bonded body 5 obtained by bonding the base member 1 and the opposite substrate 4 together from being significantly reduced, thereby enabling to firmly bond them together.

In other words, if the average thickness of the bonding film 3 is lower than the above lower limit value, there is a case that the bonded body 5 having sufficient bonding strength between the base member 1 and the opposite substrate 4 cannot be obtained. In contrast, if the average thickness of the bonding film 3 exceeds the above upper limit value, there is a fear that dimensional accuracy of the bonded body 5 is reduced significantly.

In addition, in the case where the average thickness of the bonding film 3 is set to the above range, the bonding film 3 can have a certain degree of shape following property. Therefore, even if irregularities exist on a bonding surface (a surface to be adjoined to the bonding film 3) of the substrate 2, the bonding film 3 can be formed so as to assimilate the irregularities of the bonding surface of the substrate 2, though it may be affected depending on sizes (heights) thereof.

As a result, it is possible to suppress sizes of irregularities of the surface 35 of the bonding film 3, which would be generated according to the irregularities of the bonding surface of the substrate 2, from being extremely enlarged. Namely, it is possible to improve flatness of the surface 35 of the bonding film 3. This makes it possible to improve bonding strength between the bonding film 3 and the opposite substrate 4.

The thicker the thickness of bonding film 3 is, the higher degrees of the above flatness of the surface 35 and shape following property of the bonding film 3 become. Therefore, it is preferred that the thickness of the bonding film 3 is as thick as possible in order to further improve the degrees of the flatness of the surface 35 and the shape following property of the bonding film 3.

Such a bonding film 3 is produced by the plasma polymerization method. According to the plasma polymerization method, it is possible to efficiently produce a compact and homogenous bonding film 3. Therefore, the bonding film 3 makes it possible to firmly be bonded to the opposite substrate 4.

Further, the bonding film 3 produced by using the plasma polymerization method can maintain a state activated by applying energy thereto for a long period of time. Therefore, it is possible to simplify and streamline the producing process of the bonded body 5.

Hereinafter, a description will be made on a method of producing a bonding film 3.

First, prior to the description of the method of producing the bonding film 3, a description will be made on a plasma polymerization apparatus used for producing the bonding film 3 on the substrate 2 by using the plasma polymerization method.

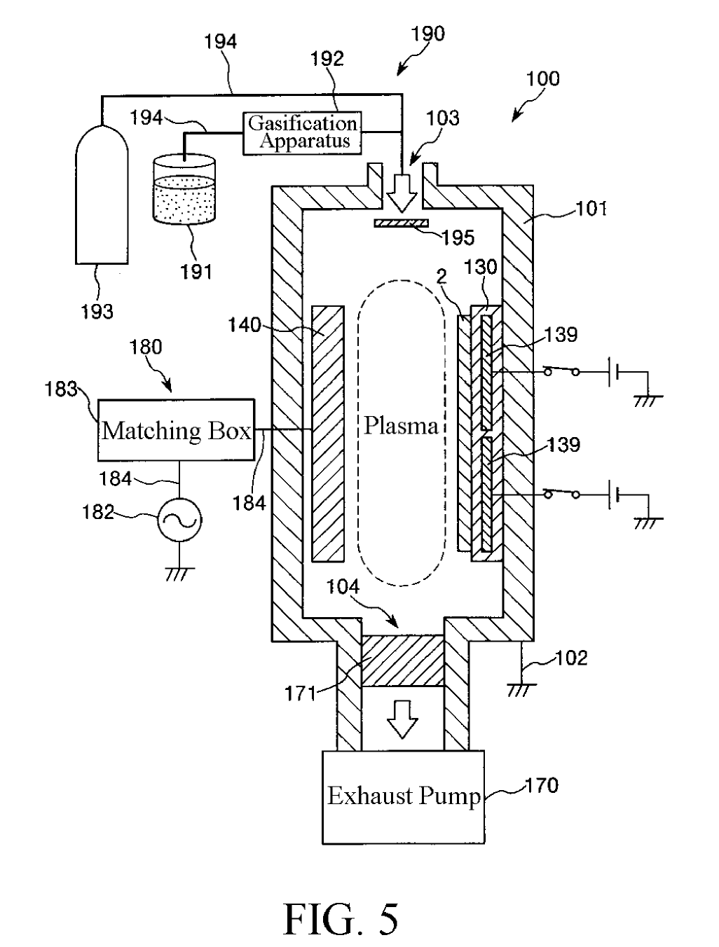

FIG. 5 is a vertical section view schematically showing a plasma polymerization apparatus used for a bonding method according to the present invention. In the following description, the upper side in FIG. 5 will be referred to as “upper” and the lower side thereof will be referred to as “lower” for convenience of explanation.

The plasma polymerization apparatus 100 shown in FIG. 5 includes a chamber 101, a first electrode 130 formed on an inner surface of the chamber 101, a second electrode 140 facing the first electrode 130, a power circuit 180 for applying a high-frequency voltage across the first electrode 130 and the second electrode 140, a gas supply part 190 for supplying a gas into the chamber 101, and a exhaust pump 170 for exhausting the gas supplied into the chamber 101 by the gas supply part 190.

Among these parts, the first electrode 130 and the second electrode 140 are provided in the chamber 101. Hereinafter, a description will be made on these parts in detail.

The chamber 101 is a vessel that can maintain air-tight condition of the inside thereof. Since the chamber 101 is used in a state of a reduced pressure (vacuum) of the inside thereof, the chamber 101 has pressure resistance property which is property that can withstand a pressure difference between the inside and the outside of the chamber 101.

The chamber 101 shown in FIG. 5 is composed from a chamber body of a substantially cylindrical shape, of which axial line is provided along a vertical direction. A supply opening 103 is provided in an upper side of the chamber 101. An exhaust opening 104 is provided in a lower side of the chamber 101.

A gas pipe 194 of the gas supply part 190 is connected to the supply opening 103. The exhaust pump 170 is connected to the exhaust opening 104.

In the present embodiment, the chamber 101 is constituted of a metal material having high conductive property and is electrically grounded through a grounding conductor 102.

The first electrode 130 has a plate shape and supports the substrate 2. In other words, the substrate 2 is provided on the surface of the first electrode 130. The first electrode 130 is provided on the inner surface of the chamber 101 along a vertical direction. In this way, the first electrode 130 is electrically grounded through the chamber 101 and the grounding conductor 102. In this regard, it is to be noted that the first electrode 130 is formed in a concentric manner as the chamber body as shown in FIG. 5.

An electrostatic chuck (attraction mechanism) 139 is provided in the first electrode 130. As shown in FIG. 5, the substrate 2 can be attracted by the electrostatic chuck 139 along the vertical direction. With this structure, even if some warpage have been formed to the substrate 2, the substrate 2 can be subjected to a plasma treatment in a state that the warpage is corrected by attracting the substrate 2 to the electrostatic chuck 139.

The second electrode 140 is provided in facing the first electrode 130 through the substrate 2. In this regard, it is to be noted that the second electrode 140 is provided in a spaced-apart relationship (a state of insulating) with the inner surface of the chamber 101.

A high-frequency power 182 is connected to the second electrode 140 through a wire 184 and a matching box 183. The matching box 183 is provided on the way of wire 184 which is provided between the second electrode 140 and the high-frequency power 182. The power circuit 180 is composed from the wire 184, the high-frequency power 182 and the matching box 183.

According to the power circuit 180, a high-frequency voltage is applied across the first electrode 130 and the second electrode 140 due to ground of the first electrode 130. Therefore, an electric field in which a movement direction of an electronic charge carrier is alternated in high frequency is formed between the first electrode 130 and the second electrode 140. The gas supply part 190 supplies a predetermined gas into the chamber 101.

The gas supply part 190 shown in FIG. 5 has a liquid reservoir part 191 for reserving a film material in a liquid form (raw liquid), a gasification apparatus 192 for changing the film material in the liquid form to the film material in a gas form, and a gas cylinder 193 for reserving a carrier gas.

The liquid reservoir part 191, the gasification apparatus 192, the gas cylinder 193 and the supply part 103 of the chamber 101 are connected with a wire 194. A mixture gas of the film material in the gas form and the carrier gas are supplied from the supply part 103 into the chamber 101.

The film material in the liquid form reserved in the liquid reservoir part 191 is a raw material that is polymerized by using the plasma polymerization apparatus 100 so that a plasma polymerization film is formed on the surface of the substrate 2. Such a film material in the liquid form is gasified by the gasification apparatus 192, thereby changing to the film material in the gas form (raw gas). Then, the film material in the gas form is supplied into the chamber 101. In this regard, the raw gas will be described later in detail.

The carrier gas reserved in the gas cylinder 193 is discharged in the electric field and supplied in the chamber 101 in order to maintain the discharge. Examples of such a carrier gas include Ar gas, He gas and the like. A diffuser plate 195 is provided near the supply part 103 of the inside of the chamber 101.

The diffuser plate 195 has a function of accelerating diffusion of the mixture gas supplied into the chamber 101. This makes it possible to uniformly diffuse the mixture gas in the chamber 101.

The exhaust pump 170 exhausts the mixture gas in the chamber 101 and is composed from a oil-sealed rotary pump, a turbo-molecular pump or the like. By exhausting an air and reducing pressure in the chamber 101, it is possible to easily change the mixture gas to plasma.

Further, it is also possible to prevent the substrate 2 from being contaminated or oxidized by contacting with the atmosphere. Furthermore, it is also possible to efficiently remove reaction products obtained by subjecting the substrate 2 to plasma polymerization apparatus 100 from the inside of the chamber 101.

A pressure control mechanism 171 for adjusting the pressure in the chamber 101 is provided in the exhaust opening 104. This makes it possible to appropriately set the pressure in the chamber 101 depending on a supply amount of the mixture gas.

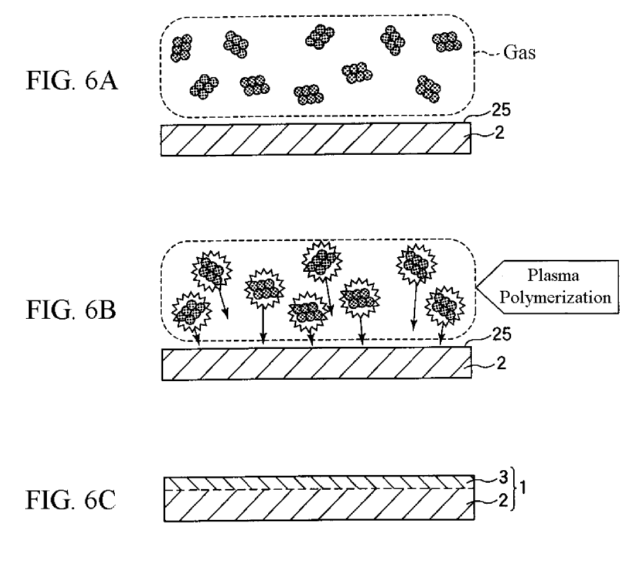

Next, a description will be made on a method of producing the bonding film 3 on the substrate 2 by using the plasma polymerization apparatus 100 described above. FIGS. 6A to 6C are longitudinal sectional views for explaining a method of forming a bonding film on a substrate. In the following description, the upper side in FIGS. 6A to 6C will be referred to as “upper” and the lower side thereof will be referred to as “lower” for convenience of explanation.

A mixture gas of a raw gas and a carrier gas is supplied into a strong electrical field to thereby polymerize molecules contained in the raw gas, so that a polymer is deposited on the substrate 2. Hereinafter, a description will be made on the concrete method.

First, the substrate 2 is prepared. Next, if needed, the surface (bonding surface) 25 of the substrate 2 is subjected to a surface treatment as described above.

Next, the substrate 2 is placed into the chamber 101 of the plasma polymerization apparatus 100. After the chamber is sealed, a pressure inside the chamber 101 is reduced by activating the exhaust pump 170.

Next, the mixture gas of the raw gas and the carrier gas is supplied into the chamber 101 by activating the gas supply part 190, thereby the chamber 101 is filled with the supplied mixture gas (FIG. 6A).

A ratio (mix ratio) of the raw gas in the mixture gas is preferably set in the range of about 20 to 70% and more preferably in the range of about 30 to 60%, though the ratio is slightly different depending on a kind of raw gas or carrier gas and an intended deposition speed. This makes it possible to optimize conditions for forming (depositing) the polymerization film (that is, the bonding film 3).

A flow rate of the supplying mixture gas, namely each of the raw gas and the carrier gas, is appropriately decided depending on a kind of raw gas or carrier gas, an intended deposition speed, a thickness of a film to be formed or the like. The flow rate is not particularly limited to a specific rate, but normally is preferably set in the range of about 1 to 100 ccm and more preferably in the range of about 10 to 60 ccm.

Next, a high-frequency voltage is applied across the first electrode 130 and the second electrode 140 by activating the power circuit 180. In this way, the molecules contained in the raw gas which exists between the first electrode 130 and the second electrode 140 are allowed to ionize, thereby generating plasma.

Then, the molecules contained in the raw gas are polymerized by plasma energy to obtain polymers, thereafter the obtained polymers are allowed to adhere to the surface 25 of the substrate 2 and are deposited thereon as shown in FIG. 6B. As a result, as shown in FIG. 6C, the bonding film 3 constituted of the plasma polymerization film is formed on the surface 25 of the substrate 2.

In this regard, the surface 25 of the substrate 2 is activated and cleared by the action of the plasma. Therefore, the polymers of the molecules contained in the raw gas are easily deposited on the surface 25 of the substrate 2. As a result, it is possible to reliably form a bonding film 3 stably. According to the plasma polymerization method, it is possible to obtain high bonding strength between the substrate 2 and the bonding film 3 despite of the constituent material of the substrate 2.

Examples of the raw gas to be contained in the mixture gas include organosiloxane such as methyl siloxane, octamethyl trisiloxane, decamethyl tetrasilixane, decamethyl cyclopentasiloxane, octamethyl cyclotetrasiloxane, and methylphenylsiloxane and the like.

The plasma polymerization film obtained by using such a raw gas, namely the bonding film 3 (polymers) is obtained by polymerizing the raw materials thereof. That is to say, the bonding film 3 is constituted of polyorganosiloxane.

In the plasma polymerization, a frequency of the high-frequency voltage applied between the first electrode 130 and the second electrode 140 is not particularly limited to a specific value, but is preferably in the range of about 1 kHz to 100 MHz and more preferably in the range of about 10 to 60 MHz.

An output density of the high-frequency voltage is not particularly limited to a specific value, but is preferably in the range of about 0.01 to 100 W/cm², more preferably in the range of about 0.1 to 50 W/cm² and even more preferably in the range of about 1 to 40 W/cm².

By setting the output density of the high-frequency voltage to a value within the above range, it is possible to reliably form the Si-skeleton 301 of which constituent atoms are bonded to each other while preventing excessive plasma energy from being applied to the raw gas due to too high output density of the high-frequency voltage.

If the output density of the high-frequency voltage is smaller than the lower limit value noted above, the molecules contained in the raw gas can not be polymerized. Therefore, there is a possibility that the bonding film 3 can not be formed.

On the other hand, if the output density of the high-frequency voltage exceeds the upper limit value noted above, the molecules contained in the raw gas is decomposed and the elimination groups 303 are eliminated from the silicon atoms of Si-skeleton 301 of the molecules contained in the raw gas. As a result, there are possibilities that a content of the elimination group 303 contained in the Si-skeleton 301 constituting the bonding film 3 is greatly lowered and it is difficult to bond the constituent atoms of the Si-skeleton 301.

An inside pressure of the chamber 101 during the deposition is preferably in the range of about 133.3×10⁻⁵ to 1333 Pa (1×10⁻⁵ to 10 Torr) and more preferably in the range of about 133.3×10⁻⁴ to 133.3 Pa (1×10⁻⁴ to 1 Torr).

A flow rate of the raw gas is preferably in the range of about 0.5 to 200 sccm and more preferably in the range of about 1 to 100 sccm. A flow rate of the carrier gas is preferably in the range of about 5 to 750 sccm and more preferably in the range of about 10 to 500 sccm.

A time required for the deposition is preferably in the range of about 1 to 10 minutes and more preferably in the range of about 4 to 7 minutes. A temperature of the substrate 2 is preferably 25° C. or higher and more preferably in the range of about 25 to 100° C. As described above, the bonding film 3 can be obtained, thereby obtaining the base member 1.

In this regard, it is to be noted that light is transmissive in the bonding film 3. By appropriately setting formation conditions of the bonding film 3 (conditions of polymerizing using plasma, a composition of the raw gas, and the like), it is possible to adjust a refractive index of the bonding film 3.

Specifically, by improving the output density of the high-frequency voltage in the plasma polymerization method, it is possible to improve the refractive index of the bonding film 3. On the contrary, by reducing the output density of the high-frequency voltage in the plasma polymerization method, it is possible to reduce the refractive index of the bonding film 3.

According to the plasma polymerization method, the bonding film 3 having refractive index of the range of about 1.35 to 1.6 is obtained. Since such a refractive index of the bonding film 3 is close to a refractive index of each of crystal and a quartz glass, the bonding film 3 is preferably used when optical elements having a structure in which light passes through the bonding film 3 are produced.

Further, since the refractive index of the bonding film 3 can be adjusted, it is possible to produce a bonding film 3 having a predetermined refractive index.

### Second Embodiment

Next, a description will be made on a second embodiment of each of the base member of the present invention, a bonding method of bonding the base member and an opposite substrate together, that is, the bonding method of the present invention, and the bonded body of the present invention including the above base member.

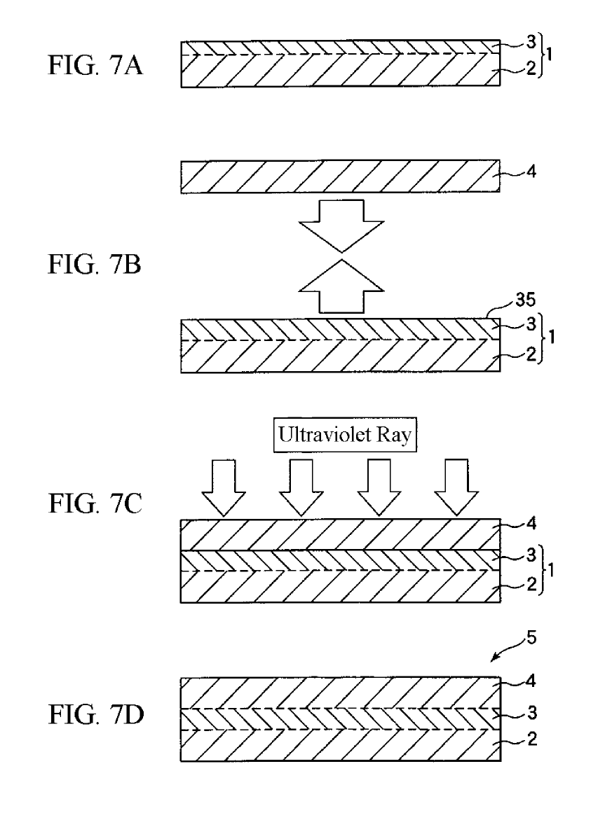

FIGS. 7A to 7D are longitudinal sectional views for explaining a second embodiment of a bonding method of bonding a base member according to the present invention to an opposite substrate (an object). In this regard, it is to be noted that in the following description, an upper side in each of FIGS. 7A to 7D will be referred to as “upper” and a lower side thereof will be referred to as “lower”.

Hereinafter, the bonding method according to the second embodiment will be described by placing emphasis on the points differing from the first embodiment, with the same matters omitted from description.

The bonding method according to this embodiment is the same as that of the first embodiment, except that after the base member 1 and the opposite substrate 4 are laminated together, the energy is applied to the bonding film 3.

In other words, the bonding method according to this embodiment includes a step of providing (preparing) the base member 1 of the present invention and the opposite substrate (the object) 4, a step of making the prepared opposite substrate 4 and the base member 1 close contact with each other through the bonding film 3 to obtain a pre-bonded body in which they are laminated together, and a step of applying the energy to the bonding film 3 in the pre-bonded body so that it is activated and the base member 1 and the opposite substrate 4 are bonded together, to thereby obtain a bonded body 5.

Hereinafter, the respective steps of the bonding method according to this embodiment will be described one after another.

[1] First, the base member 1 is prepared in the same manner as in the first embodiment (see FIG. 7A).

[2] Next, as shown in FIG. 7B, the opposite substrate 4 is prepared. Thereafter, the base member 1 and the opposite substrate 4 are laminated together so that the surface 35 of the bonding film 3 thereof and the opposite substrate 4 make close contact with each other, to obtain the pre-bonded body.

In the state of the pre-bonded body, the base member 1 and the opposite substrate 4 are not bonded together. Therefore, it is possible to adjust a relative position of the base member 1 with respect to the opposite substrate 4.

This makes it possible to finely adjust the relative position of the base member 1 with relative to the opposite substrate 4 easily by shifting them after they have been laminated (overlapped) together. As a result, it becomes possible to increase positional accuracy of the base member 1 with relative to the opposite substrate 4 in a direction of the surface 35 of the bonding film 3.

[3] Then, as shown in FIG. 7C, the energy is applied to the bonding film 3 in the pre-bonded body. In a case where the energy is applied to the bonding film 3 which makes contact with the opposite substrate 4, bonding property with respect to the opposite substrate 4 is developed on the bonding film 3.

As a result, the base member 1 and the opposite substrate 4 are bonded together due to the bonding property developed to the bonding film 3, to thereby obtain a bonded body 5 as shown in FIG. 7D. In this regard, it is to be noted that the energy may be applied to the bonding film 3 by any method including, e.g., the methods described in the first embodiment.

In this embodiment, it is preferred that at least one method selected from the group comprising a method in which an energy beam is irradiated on the bonding film 3, a method in which the bonding film 3 is heated, and a method in which a compressive force (physical energy) is applied to the bonding film 3 is used as the method of applying the energy to the bonding film 3.

The reason why these methods are preferred as the energy application method is that they are capable of relatively easily and efficiently applying the energy to the bonding film 3.

Among these methods, the same method as employed in the first embodiment can be used as the method in which the energy beam is irradiated on the bonding film 3. In this case, the energy beam is transmitted through the substrate 2 and is irradiated on the bonding film 3, or the energy beam is transmitted through the opposite substrate 4 and is irradiated on the bonding film 3. For this reason, between the substrate 2 and the opposite substrate 4, the substrate on which the energy beam is irradiated has transparency.

On the other hand, in the case where the energy is applied to the bonding film 3 by heating the bonding film 3, a heating temperature is preferably in the range of about 25 to 100° C., and more preferably in the range of about 50 to 100° C. If the bonding film 3 is heated at a temperature of the above range, it is possible to reliably activate the bonding film 3 while reliably preventing the substrate 2 and the opposite substrate 4 from being thermally altered or deteriorated.

Further, a heating time is set great enough to remove the elimination groups 303 included in the bonding film 3. Specifically, the heating temperature may be preferably in the range of about 1 to 30 minutes if the heating temperature is set to the above mentioned range. Furthermore, the bonding film 3 may be heated by any method. Examples of the heating method include various kinds of methods such as a method using a heater, a method of irradiating an infrared ray and a method of making contact with a flame.

In the case of using the method of irradiating the infrared ray, it is preferred that the substrate 2 or the opposite substrate 4 is made of a light-absorbing material. This ensures that the substrate 2 or the opposite substrate 4 can generate heat efficiently when the infrared ray is irradiated thereon. As a result, it is possible to efficiently heat the bonding film 3.

Further, in the case of using the method using the heater or the method of making contact with the flame, it is preferred that, the substrate 2 and the opposite substrate 4 are made of a material that exhibits superior thermal conductivity. This makes it possible to efficiently transfer the heat to the bonding film 3 through the substrate 2 or the opposite substrate 4, thereby efficiently heating the bonding film 3.

Furthermore, in the case where the energy is applied to the bonding film 3 by applying the compressive force to the bonding film 3, it is preferred that the base member 1 and the opposite substrate 4 are compressed against each other. Specifically, a pressure in compressing them is preferably in the range of about 0.2 to 10 MPa, and more preferably in the range of about 1 to 5 MPa.

This makes it possible to easily apply appropriate energy to the bonding film 3 by merely performing a compressing operation, which ensures that a sufficiently high bonding property with respect to the opposite substrate 4 is developed in the bonding film 3. Although the pressure may exceed the above upper limit value, it is likely that damages and the like occur in the substrate 2 and the opposite substrate 4, depending on the constituent materials thereof.

Further, a compressing time is not particularly limited to a specific value, but is preferably in the range of about 10 seconds to 30 minutes. In this regard, it is to be noted that the compressing time can be suitably changed, depending on magnitude of the compressive force. Specifically, the compressing time can be shortened as the compressive force becomes greater.

In the manner described above, it is possible to obtain a bonded body 5 in which the base member 1 is bonded to the opposite substrate 4.

After the bonded body 5 has been obtained, if necessary, at least one step of three steps <4A>, <4B>, and <4C> in the first embodiment may be carried out to the bonded body 5.

### Third Embodiment

Next, a description will be made on a third embodiment of each of a base member of the present invention, a bonding method of bonding the base member and an opposite substrate together, that is, the bonding method of the present invention, and the bonded body of the present invention including the above base member.

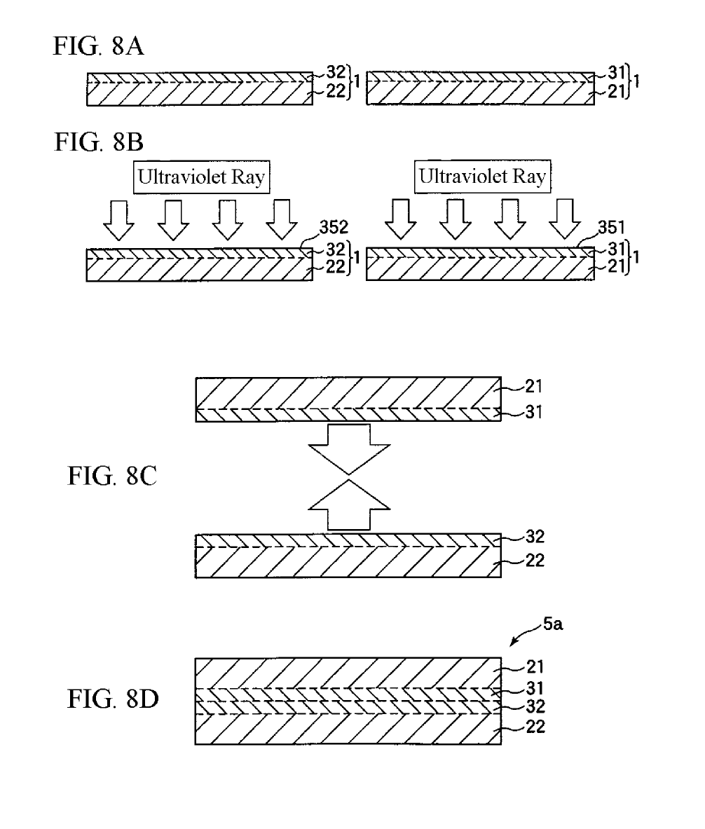

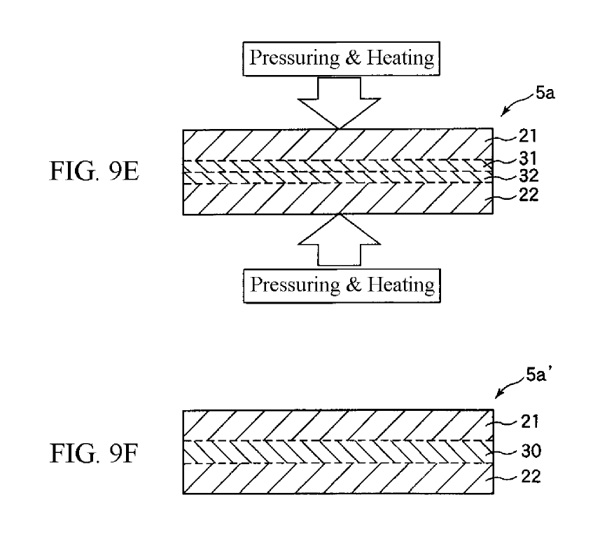

FIGS. 8A to 8D, 9E and 9F are longitudinal sectional views for explaining a third embodiment of a bonding method of bonding a base member according to the present invention to an opposite substrate (an object).

In this regard, it is to be noted that in the following description, an upper side in each of FIGS. 8A to 8D, 9E and 9F will be referred to as “upper” and a lower side thereof will be referred to as “lower”.

Hereinafter, the bonding method according to the third embodiment will be described by placing emphasis on the points differing from the first and second embodiments, with the same matters omitted from description.

The bonding method according to this embodiment is the same as that of the first embodiment, except that two base members 1 (that is, a first base member 1 and a second base member 1) are bonded together.

In other words, the bonding method according to this embodiment includes a step of providing (preparing) two base members 1 each having a bonding film 31 or a bonding film 32, a step of applying the energy to the bonding films 31 and 32 of the base members 1 so that they are activated, and a step of making the two base members 1 close contact with each other through the bonding films 31 and 32 so that they are bonded together, to thereby obtain a bonded body 5a.

Hereinafter, the respective steps of the bonding method according to this embodiment will be described one after another.

[1] First, two base members 1 are prepared in the same manner as in the first embodiment (see FIG. 8A).

In this embodiment, as shown in FIG. 8A, as the two base members 1, used are a base member (a first base member) 1 having a substrate 21 and a bonding film 31 provided on the substrate 21, and a base member (a second base member) 1 having a substrate 22 and a bonding film 32 provided on the substrate 22.

[2] Next, as shown in FIG. 8B, the energy is applied to the bonding films 31 and 32 of the two base members 1.

In a case where the energy is applied to the bonding films 31 and 32, respectively, at least a part of the elimination groups 303 illustrated in FIG. 3 are removed from the silicon atoms of the Si-skeleton 301. After the elimination groups 303 have been removed, the active hands 304 are generated in the vicinity of the surfaces 351, 352 and the inside of the bonding films 31 and 32 as shown in FIG. 4.

In this state, the bonding films 31 and 32 are activated, that is, bonding property is developed on the bonding films 31 and 32. The two base members 1 each having the above state are rendered bondable to each other. In this regard, it is to be noted that the same method as employed in the first embodiment can be used as the energy application method.

In this regard, it is to be noted that the phrase “the bonding film 3 is activated” means any one of the following states. The first state is a state that the elimination groups 303 bonded to the silicon atoms in the surfaces 351 and 352 and the inside of the bonding films 31 and 32 are eliminated, thereby generating bonding hands (non-bonding hands) not to be end-capped in the silicon atoms of the Si-skeleton 301 (hereinafter simply referred to as “non-bonding hands” or “dangling-bond”).

The second state is a state that the bonding hands are end-capped by hydroxyl groups (OH groups). The third state is a state that the first state and the second state are co-existed. Therefore, the active hands 304 mean the non-bonding hands (dangling-bond) or hands in which the bonding hands are end-capped by the hydroxyl groups.

[3] Then, as shown in FIG. 8C, the two base members 1 are laminated together so that the bonding films 31 and 32 each having the bonding property thus developed make close contact with each other, to thereby obtain a bonded body 5a. In this step, the two base members 1 are bonded together. It is conceived that this bonding results from one or both of the following mechanisms (i) and (ii).

Hereinafter, a description will be representatively offered regarding a case that hydroxyl groups are exposed on the surfaces 351 and 352 of the bonding films 31 and 32.

(i) When the two base members 1 are laminated together so that the bonding films 31 and 32 make close contact with each other, the hydroxyl groups existing on the surfaces 351 and 352 of the bonding films 31 and 32 thereof are attracted together, as a result of which hydrogen bonds are generated between the above adjacent hydroxyl groups. It is conceived that the generation of the hydrogen bonds makes it possible to bond the two base members 1 together.

Depending on conditions such as a temperature and the like, the hydroxyl groups bonded together through the hydrogen bonds are dehydrated and condensed, so that the hydroxyl groups and/or water molecules are removed from the bonding surface (the contact surface) between the two base members 1. As a result, two atoms, to which the hydroxyl groups had been bonded, are bonded together directly or via an oxygen atom. In this way, it is conceived that the base members 1 are firmly bonded together.

(ii) When the two base members 1 are laminated together, the dangling bonds (non-bonding hands) not to be end-capped generated in the vicinity of the surfaces 351 and 352 and the inside of the bonding films 31 and 32 are bonded together. This bonding occurs in a complicated fashion so that the dangling bonds are inter-linked.

As a result, network-like bonds are formed in the bonding interface between the base members 1. This ensures that either the silicon atoms or the oxygen atoms of the Si-skeleton 301 constituting the bonding films 31 and 32 are directly bonded together, as a result of which respective bonding films 31 and 32 are united (bonded) together.

By the above mechanism (i) and/or mechanism (ii), it is possible to obtain the bonded body 5a as shown in FIG. 8D.

If necessary, the bonded body 5a thus obtained may be subjected to at least one of the steps [4A], [4B] and [4C] in the first embodiment.

For example, if the bonded body 5a is heated while compressing the same as shown in FIG. 9E, the substrates 21 and 22 in the bonded body 5a come closer to each other. This accelerates dehydration and condensation of the hydroxyl groups and/or bonding of the dangling bonds in the interface between the bonding films 31 and 32. Thus, unification (bonding) of the bonding films 31 and 32 is further progressed. As a result, as shown in FIG. 9E, it is possible to obtain a bonded body 5a′ having a substantially completely united bonding film.

### Fourth Embodiment

Next, a description will be made on a fourth embodiment of each of abase member of the present invention, a bonding method of bonding the base member and an opposite substrate together, that is, the bonding method of the present invention, and the bonded body of the present invention including the above base member.

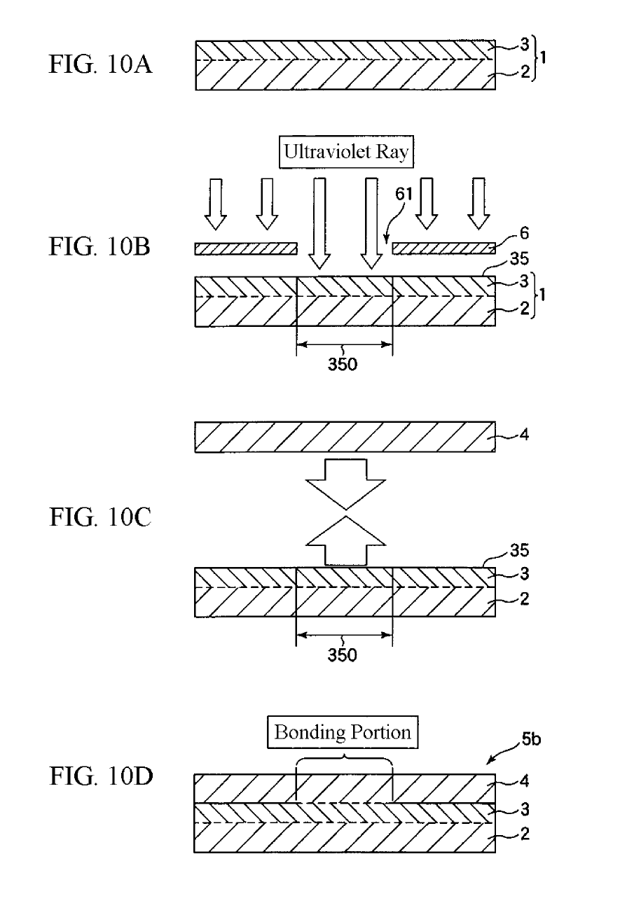

FIGS. 10A to 10D are longitudinal sectional views for explaining a fourth embodiment of a bonding method of bonding a base member according to the present invention to an opposite substrate (object). In this regard, it is to be noted that in the following description, an upper side in each of FIGS. 10A to 10D will be referred to as “upper” and a lower side thereof will be referred to as “lower”.

Hereinafter, the bonding method according to the fourth embodiment will be described by placing emphasis on the points differing from the first to third embodiments, with the same matters omitted from description.

The bonding method according to this embodiment is the same as that of the first embodiment, except that only a predetermined region 350 of the bonding film 3 is selectively activated, and the base member 1 and the opposite substrate 4 are partially bonded together at the predetermined region 350.

In other words, the bonding method according to this embodiment includes a step of providing (preparing) the base member 1 of the present invention and the opposite substrate (the object) 4, a step of applying the energy to the predetermined region 350 of the bonding film 3 of the base member 1 so that it is selectively activated, and a step of making the prepared opposite substrate 4 and the base member 1 contact with each other through the bonding film 3 so that they are partially bonded together at the predetermined region 350, to thereby obtain a bonded body 5b.

Hereinafter, the respective steps of the bonding method according to this embodiment will be described one after another.

[1] First, the base member 1 (the base member of the present invention) is prepared (see FIG. 10A).

[2] Next, as shown in FIG. 10B, the energy is selectively applied to the predetermined region 350 of the surface 35 of the bonding film 3 of the base member 1.

In a case where the energy is applied to the predetermined region 350 of the bonding film 3, at least a part of the elimination groups 303 shown in FIG. 3 are removed from the silicon atoms of the Si-skeleton 301. After the elimination groups 303 have been removed, the active hands 304 are generated in the vicinity of the surface 35 and the inside of the bonding film 3 in the predetermined region 350 as shown in FIG. 4.

In this state, the bonding film 3 is activated, that is, a bonding property with respect to the opposite substrate 4 is developed in the predetermined region 350 of the bonding film 3. In contrast, little or no bonding property is developed in a region of the bonding film 3 other than the predetermined region 350.

The base member 1 having the above state is rendered partially bondable to the opposite substrate 4 at the predetermined region 350.

In this regard, it is to be noted that the energy may be applied to the bonding film 3 by any method including, e.g., the methods described in the first embodiment. In this embodiment, it is particularly preferred that a method of irradiating an energy beam on the bonding film 3 is used as the energy application method. The reason why this method is preferred as the energy application method is that it is capable of relatively easily and efficiently applying the energy to the bonding film 3.

Further, in this embodiment, it is preferred that energy beams having high directionality such as a laser beam and an electron beam are used as the energy beam. Use of these energy beams makes it possible to selectively and easily irradiate the energy beam on the predetermined region 350 by irradiating it in a target direction.

Even in the case where an energy beam with low directionality is used, it is possible to selectively irradiate the energy beam on the predetermined region 350 of the surface 35 of the bonding film 3, if radiation thereof is performed by covering (shielding) a region other than the predetermined region 350 to which the energy beam is to be irradiated.

Specifically, as shown in FIG. 10B, a mask 6 having a window portion 61 whose shape corresponds to a shape of the predetermined region 350 may be provided above the surface 35 of the bonding film 3. Then, the energy beam may be irradiated through the mask 6. By doing so, it is easy to selectively irradiate the energy beam on the predetermined region 350.

[3] Next, the opposite substrate (the object) 4 is prepared as shown in FIG. 10C. Then, the base member 1 and the opposite substrate 4 are laminated together so that the bonding film 3 having the selectively activated predetermined region 350 makes close contact with the opposite substrate 4. This makes it possible to obtain a bonded body 5b shown in FIG. 10D.

In the bonded body 5b thus obtained, the base member 1 and the opposite substrate 4 are not bonded together in the entire of an interface therebetween, but partially bonded together only in a partial region (the predetermined region 350). During this bonding operation, it is possible to readily select a bonded region by merely controlling an energy application region of the bonding film 3.

This makes it possible to control, e.g., an area of the activated region (the predetermined region 350 in this embodiment) of the bonding film 3 of the base member 1, which in turn makes it possible to easily adjust the bonding strength between the base member 1 and the opposite substrate 4. As a result, there is provided a bonded body 5b that allows a bonded portion to be separated easily.

Further, it is also possible to reduce local concentration of stress which would be generated in the bonded portion by suitably controlling an area and shape of the bonded portion (the predetermined region 350) of the base member 1 and the opposite substrate 4 shown in FIG. 10D.

This makes it possible to reliably bond the base member 1 and the opposite substrate 4 together, e.g., even in the case where the substrate 2 and the opposite substrate 4 exhibit a large difference in their thermal expansion coefficients.

In addition, in the bonded body 5b, a tiny gap is generated (or remains) between the base member 1 and the opposite substrate 4 in the region other than the predetermined bonding region 350. This means that it is possible to easily form closed spaces, flow paths or the like between the base member 1 and the opposite substrate 4 by suitably changing the shape of the predetermined region 350.

As described above, it is possible to adjust the bonding strength between the base member 1 and the opposite substrate 4 and separating strength (splitting strength) therebetween by controlling the area of the bonded portion (the predetermined region 350) between the base member 1 and the opposite substrate 4.

From this standpoint, it is preferred that, in the case of producing an easy-to-separate bonded body 5b, the bonding strength between the base member 1 and the opposite substrate 4 is set enough for the human hands to separate the bonded body 5b. By doing so, it becomes possible to easily separate the bonded body 5b without having to use any device or tool.

In the manner described above, it is possible to obtain the bonded body 5b.

If necessary, the bonded body 5b thus obtained may be subjected to at least one of the steps [4A], [4B] and [4C] in the first embodiment.

At this time, the tiny gap is generated (or remains) in the region (a non-bonding region), other than the predetermined region 350, of the interface between the bonding film 3 and the opposite substrate 4 in the bonded body 5b. Therefore, it is preferred that the compressing and heating of the bonded body 5b is performed under the conditions in that the bonding film 3 and the opposite substrate 4 are not bonded together in the region other than the predetermined region 350.

Taking the above situations into account, it is preferred that the predetermined region 350 is preferentially subjected to at least one of the steps [4A], [4B] and [4C] in the first embodiment, when such a need arises. This makes it possible to prevent the bonding film 3 and the opposite substrate 4 from being bonded together in the region other than the predetermined region 350.

### Fifth Embodiment

Next, a description will be made on a fifth embodiment of each of a base member of the present invention, a bonding method of bonding the base member and an opposite substrate together, that is, the bonding method of the present invention, and the bonded body of the present invention including the above base member.

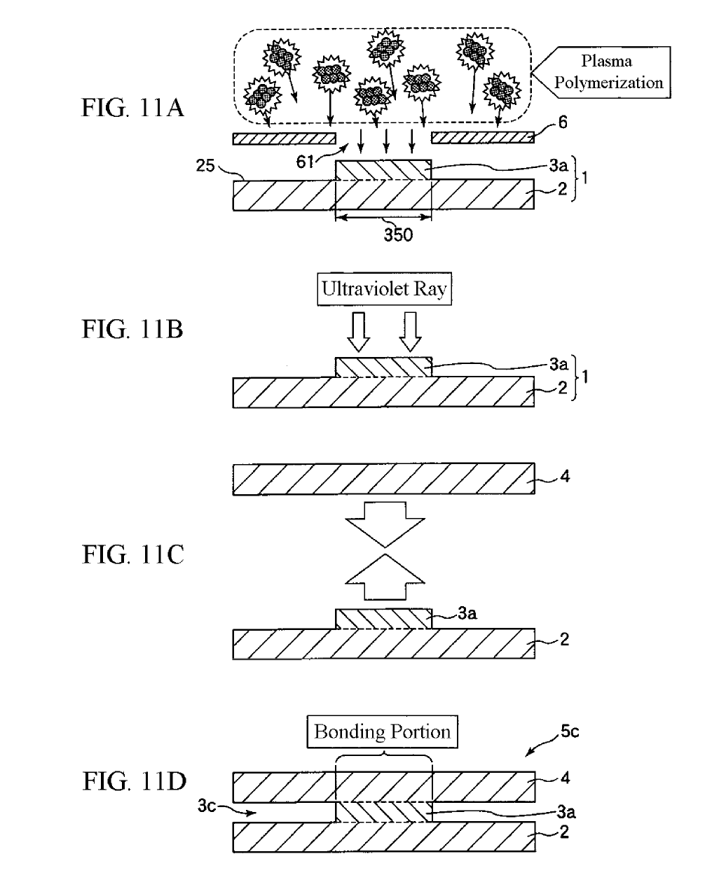

FIGS. 11A to 11D are longitudinal sectional views for explaining a fifth embodiment of a bonding method of bonding a base member according to the present invention to an opposite substrate (an object).

In this regard, it is to be noted that in the following description, an upper side in each of FIGS. 11A to 11D will be referred to as “upper” and a lower side thereof will be referred to as “lower”.

Hereinafter, the bonding method according to the fifth embodiment will be described by placing emphasis on the points differing from the first to fourth embodiments, with the same matters omitted from description.

The bonding method according to this embodiment is the same as that of the first embodiment, except that a base member 1 is obtained by selectively forming a bonding film 3a only in a predetermined region 350 of an upper surface 25 of the substrate 2, and the base member 1 and the opposite substrate 4 are partially bonded together in the predetermined region 350.

In other words, the bonding method according to this embodiment includes a step of providing (preparing) the base member 1 having the substrate 2 and the bonding film 3a which is formed on only the predetermined region 350 of the substrate 2, a step of applying the energy to the bonding film 3a of the base member 1 so that it is activated, preparing the opposite substrate (the object) 4, and a step of making the prepared opposite substrate 4 and the base member 1 contact with each other through the bonding film 3a so that they are bonded together through the bonding film 3a, to thereby obtain a bonded body 5c.

Hereinafter, the respective steps of the bonding method according to this embodiment will be described one after another.

[1] First, as shown in FIG. 11A, a mask 6 having a window portion 61 whose shape corresponds to a shape of the predetermined region 350 is provided above the substrate 2.

Then, the bonding film 3a is formed on the upper surface 25 of the substrate 2 through the mask 6. As shown in FIG. 11A, in the case where a plasma polymerization method is used as the method of forming the bonding film 3a, by applying a polymerized matter produced by the plasma polymerization method onto the surface 25 of the substrate 2 through the mask 6, the polymerized matter is selectively deposited on the predetermined region 350 to thereby form the bonding film 3a thereon.

[2] Next, the energy is applied to the bonding film 3a as shown in FIG. 11B. By doing so, a bonding property with respect to the opposite substrate 4 is developed in the bonding film 3a of the base member 1.

During the application of the energy in this step, the energy may be applied selectively to the bonding film 3a or to the entirety of the upper surface 25 of the substrate 2 including the bonding film 3a. Further, the energy may be applied to the bonding film 3a by any method including, e.g., the methods described in the first embodiment.

[3] Next, the opposite substrate (the object) 4 is prepared as shown in FIG. 11C. Then, the base member 1 and the opposite substrate 4 are laminated together so that the bonding film 3a and the opposite substrate 4 make close contact with each other. This makes it possible to obtain a bonded body 5c as shown in FIG. 11D.

In the bonded body 5c thus obtained, the substrate 2 and the opposite substrate 4 are not bonded together in the entire of an interface therebetween, but partially bonded together only in a partial region (the predetermined region 350). During the formation of the bonding film 3a, it is possible to easily select a bonded region by merely controlling the film formation region.

This makes it possible to control, e.g., an area of the region (the predetermined region 350) in which the bonding film 3a is formed, which in turn makes it possible to easily adjust the bonding strength between the base member 1 and the opposite substrate 4. As a result, there is provided a bonded body 5c that allows a bonded portion to be separated easily.

Further, it is possible to reduce local concentration of stress which would be generated in the bonded portion by suitably controlling an area and shape of the bonded portion (the predetermined region 350) of the base member 1 and the opposite substrate 4 shown in FIG. 11D.

This makes it possible to reliably bond the base member 1 and the opposite substrate 4 together, e.g., even in the case where the substrate 2 and the opposite substrate 4 exhibit a large difference in their thermal expansion coefficients.

In addition, between the substrate 2 and the opposite substrate 4 in the bonded body 5c, a gap 3c having a size corresponding to the thickness of the bonding film 3a is formed in the region other than the predetermined region 350 (see FIG. 11D).

This means that it is possible to easily form closed spaces, flow paths or the like each having a desired shape between the substrate 2 and the opposite substrate 4 by suitably changing the shape of the predetermined region 350 and the thickness of the bonding film 3a.

In the manner described above, it is possible to obtain the bonded body 5c.

If necessary, the bonded body 5c thus obtained may be subjected to at least one of the steps [4A], [4B] and [4C] in the first embodiment.

### Sixth Embodiment

Next, a description will be made on a sixth embodiment of each of a base member of the present invention, a bonding method of bonding the base member and an opposite substrate together, that is, the bonding method of the present invention, and the bonded body of the present invention including the above base member.

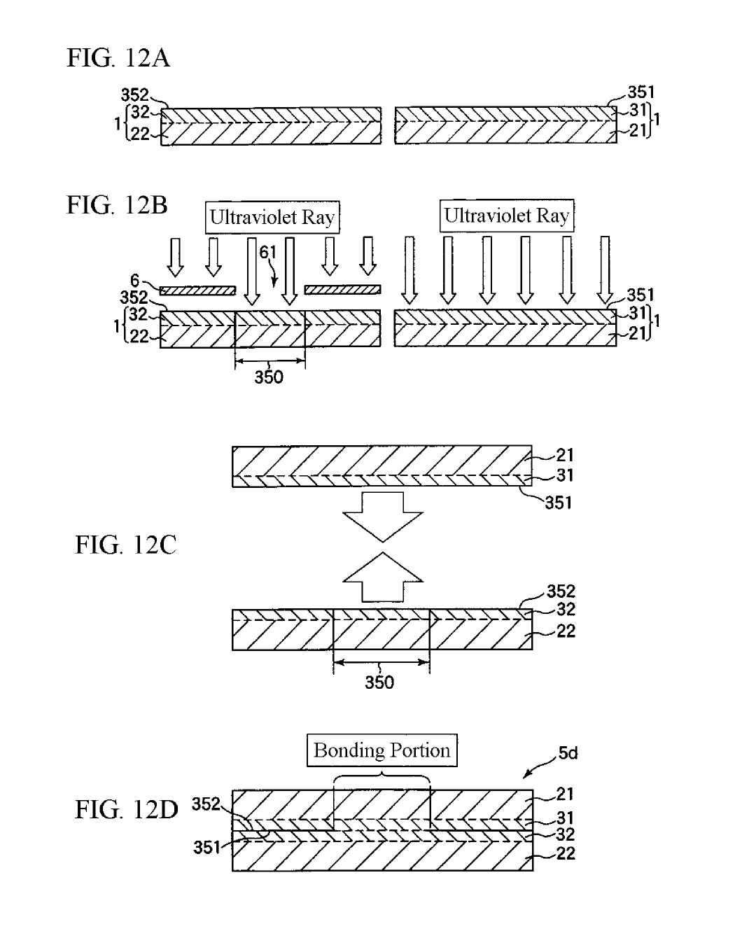

FIGS. 12A to 12D are longitudinal sectional views for explaining a sixth embodiment of a bonding method of bonding a base member according to the present invention to an opposite substrate (an object).

In this regard, it is to be noted that in the following description, an upper side in each of FIGS. 12A to 12D will be referred to as “upper” and a lower side thereof will be referred to as “lower”.

Hereinafter, the bonding method according to the sixth embodiment will be described by placing emphasis on the points differing from the first to fifth embodiments, with the same matters omitted from description.

The bonding method according to this embodiment is the same as that of the first embodiment, except that two base members 1 each having a bonding film 31 or a bonding film 32 are prepared, the bonding film 31 and only a predetermined region 350 of the bonding film 32 thereof are activated, and the two base members 1 are bonded together in the predetermined region 350.

In other words, the bonding method according to this embodiment includes a step of providing (preparing) the two base members 1 each having the bonding film 31 or the bonding film 32, a step of applying the energy to different regions (the entire of the surface 351 and the predetermined region 350 of the surface 352) of the bonding films 31 and 32 of the two base members 1 so that the different regions are activated, and a step of making the base members 1 contact with each other through the bonding films 31 and 32 so that they are partially bonded together in the predetermined region 350, to thereby obtain a bonded body 5d.

Hereinafter, the respective steps of the bonding method according to this embodiment will be described one after another.

[1] First, two base members 1 are prepared in the same manner as in the first embodiment (see FIG. 12A).

In this embodiment, as shown in FIG. 12A, as the two base members 1, used are a base member (a first base member) 1 having a substrate 21 and a bonding film 31 provided on the substrate 21, and a base member (a second base member) 1 having a substrate 22 and a bonding film 32 provided on the substrate 22.

[2] Next, as shown in FIG. 12B, the energy is applied to the entirety of the surface 351 of the bonding film 31 of one base member 1. By doing so, bonding property is developed over the entirety of the surface 351 of the bonding film 31.

On the other hand, the energy is selectively applied to the predetermined region 350 of the surface 352 of the bonding film 32 of the other base member 1. The same method as employed in the fourth embodiment may be used as the method of selectively applying the energy to the predetermined region 350.

In a case where the energy is applied to the bonding films 31 and 32, respectively, the elimination groups 303 shown in FIG. 3 are removed from the silicon atoms of the Si-skeleton 301 including in each of the bonding films 31 and 32. After the elimination groups 303 have been removed, the active hands 304 are generated in the vicinity of the surfaces 351 and 352 and the insides of the bonding films 31 and 32 as shown in FIG. 4.

In this state, the bonding films 31 and 32 are activated, that is, bonding property is developed in the entirety of the surface 351 of the bonding film 31 and in the predetermined region 350 of the surface 352 of the bonding film 32, respectively.

In contrast, little or no bonding property is developed in a region of the bonding film 32 other than the predetermined region 350. The two base members 1 each having the above state are rendered partially bondable to each other in the predetermined region 350.

[3] Then, as shown in FIG. 12C, the two base members 1 are laminated together so that the bonding films 31 and 32 each having the bonding property thus developed make close contact with each other, to thereby obtain a bonded body 5d as shown in FIG. 12D.

In the bonded body 5d thus obtained, the two base members 1 are not bonded together in the entire of an interface therebetween, but partially bonded together only in a partial region (the predetermined region 350). During this bonding operation, it is possible to easily select a bonded region by merely controlling an energy application region of the bonding film 32. This makes it possible to easily control, e.g., the bonding strength between the base members 1.

In the manner described above, it is possible to obtain the bonded body 5d.

If necessary, the bonded body 5d thus obtained may be subjected to at least one of the steps [4A], [4B] and [4C] in the first embodiment.

For example, if the bonded body 5d is heated while compressing the same, the substrates 21 and 22 in the bonded body 5d come closer to each other. This accelerates dehydration and condensation of the hydroxyl groups and/or bonding of the dangling bonds in the interface between the bonding films 31 and 32. Thus, unification (bonding) of the bonding films 31 and 32 is further progressed in the bonded portion formed in the predetermined region 350. Eventually, the bonding films 31 and 32 are substantially completely united.

At this time, a tiny gap is generated (or remains) in the region (a non-bonding region), other than the predetermined region 350, of the interface between the surfaces 351 and 352 of the bonding films 31 and 32. Therefore, it is preferred that the compressing and heating of the bonded body 5d is performed under the conditions in that the bonding films 31 and 32 are not bonded together in the region other than the predetermined region 350.

Taking the above situations into account, it is preferred that the predetermined region 350 is preferentially subjected to at least one of the steps [4A], [4B] and [4C] in the first embodiment, when such a need arises. This makes it possible to prevent the bonding films 31 and 32 from being bonded together in the region other than the predetermined region 350.

### Seventh Embodiment

Next, a description will be made on a seventh embodiment of each of a base member of the present invention, a bonding method of bonding the base member and an opposite substrate together, that is, the bonding method of the present invention, and the bonded body of the present invention including the above base member.

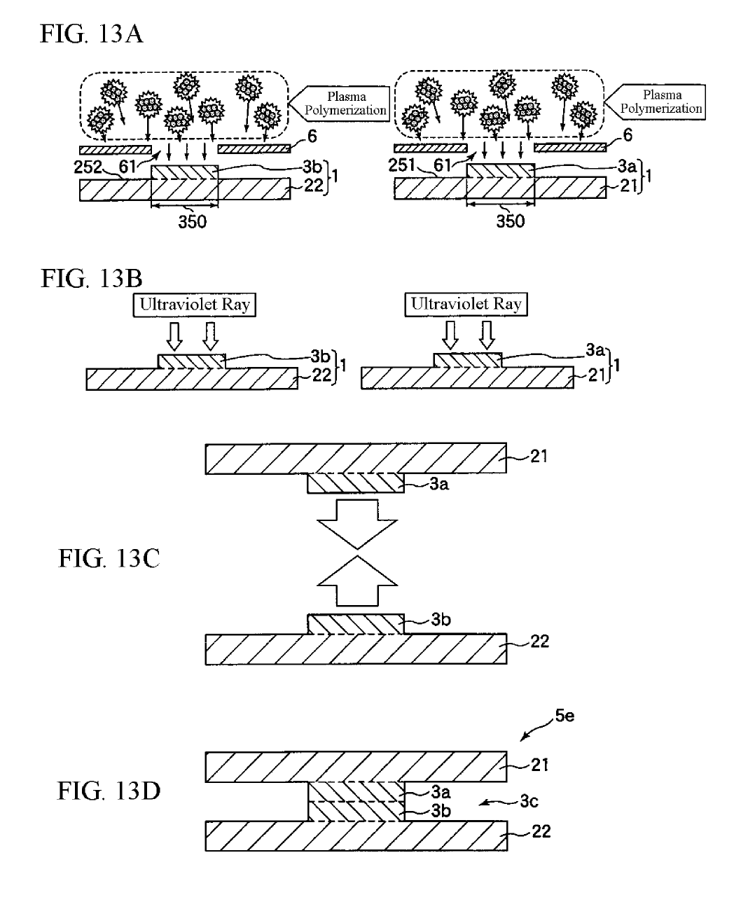

FIGS. 13A to 13D are longitudinal sectional views for explaining a seventh embodiment of a bonding method of bonding a base member according to the present invention to an opposite substrate (an object).

In this regard, it is to be noted that in the following description, an upper side in each of FIGS. 13A to 13D will be referred to as “upper” and a lower side thereof will be referred to as “lower”.

Hereinafter, the bonding method according to the seventh embodiment will be described by placing emphasis on the points differing from the first to sixth embodiments, with the same matters omitted from description.

The bonding method according to this embodiment is the same as that of the first embodiment, except that two base members 1 are obtained by selectively forming bonding films 3a and 3b only on the predetermined regions 350 of upper surfaces 251 and 252 of substrates 21 and 22, and the two base members 1 are partially bonded together through the bonding films 3a and 3b thereof.

In other words, the bonding method according to this embodiment includes a step of providing (preparing) two base members 1 each having the substrate 21 or 22 and the bonding film 3a or 3b formed in a predetermined region 350 of the substrates 21 or 22, a step of applying the energy to the bonding films 3a and 3b of the base members 1 so that they are activated, and a step of making the two base members 1 close contact with each other through the bonding films 3a and 3b so that they are partially bonded together at the predetermined region 350, to thereby obtain a bonded body 5e.

Hereinafter, the respective steps of the bonding method according to this embodiment will be described one after another.

[1] First, as shown in FIG. 13A, masks 6 each having a window 61 whose shape corresponds to a shape of the predetermined region 350 are respectively provided above the substrates 21 and 22.

Then, the bonding films 3a and 3b are respectively formed on the upper surfaces 251 and 252 of the substrates 21 and 22 through the masks 6. As shown in FIG. 13A, in the case where a plasma polymerization method is used as the method of forming the bonding films 3a and 3b, by applying a polymerized matter produced by the plasma polymerization method onto the upper surfaces 251 and 252 of the substrates 21 and 22 through the masks 6, the polymerized matter is selectively deposited on the predetermined regions 350 of the upper surfaces 251 and 252 to thereby form the bonding films 3a and 3b thereon.

As a result, it is possible to form the bonding films 3a and 3b on the predetermined regions 350 of the upper surfaces 251 and 252 of the substrates 21 and 22, respectively.

[2] Next, as shown in FIG. 13B, the energy is applied to the bonding films 3a and 3b, respectively. By doing so, bonding property is developed in each of the bonding films 3a and 3b of the base members 1.

During the application of the energy in this step, the energy may be applied selectively to the bonding films 3a and 3b or to the entirety of the upper surfaces 251 and 252 of the substrates 21 and 22 including the bonding films 3a and 3b. In this regard, it is to be noted that the energy may be applied to the bonding films 3a and 3b by any method including, e.g., the methods described in the first embodiment.

[3] Next, as shown in FIG. 13C, the two base members 1 are laminated together so that the bonding films 3a and 3b each having the bonding property thus developed make close contact with each other. This makes it possible to obtain a bonded body 5e as shown in FIG. 13D.

In the bonded body 5e thus obtained, the two base members 1 are not bonded together in the entire of an interface therebetween, but partially bonded together only in a partial region (the predetermined region 350). During the formations of the bonding films 3a and 3b, it is possible to easily select a bonded region by merely controlling the film formation regions. This makes it possible to easily control, e.g., the bonding strength between the base members 1.

In addition, between the substrates 21 and 22 in the bonded body 5e, a gap 3c having a size corresponding to a total thickness of the bonding films 3a and 3b is formed in the region other than the predetermined region 350 (see FIG. 13D).

This means that it is possible to easily form closed spaces, flow paths or the like each having a desired shape between the substrates 21 and 22 by suitably changing the shape of the predetermined region 350 and the total thickness of the bonding films 3a and 3b.

In the manner described above, it is possible to obtain the bonded body 5e. If necessary, the bonded body 5e thus obtained may be subjected to at least one of the steps [4A], [4B] and [4C] in the first embodiment.

For example, if the bonded body 5e is heated while compressing the same, the substrates 21 and 22 in the bonded body 5e come closer to each other. This accelerates dehydration and condensation of the hydroxyl groups and/or bonding of the dangling bonds in the interface between the bonding films 3a and 3b. Thus, unification (bonding) of the bonding films 3a and 3b is further progressed in the bonded portion formed in the predetermined region 350. Eventually, the bonding films 3a and 3b are substantially completely united.

The bonding methods of the respective embodiments described above can be used in bonding different kinds of members together.

Examples of an article (a bonded body) to be manufactured by these bonding methods include: semiconductor devices such as a transistor, a diode and a memory; piezoelectric devices such as a crystal oscillator and a surface acoustic wave device; optical devices such as a reflecting mirror, an optical lens, a diffraction grating and an optical filter; photoelectric conversion devices such as a solar cell; semiconductor substrates having semiconductor devices mounted thereon; insulating substrates having wirings or electrodes formed thereon; ink-jet type recording heads; parts of micro electromechanical systems such as a micro reactor and a micro mirror; sensor parts such as a pressure sensor and an acceleration sensor; package parts of semiconductor devices or electronic components; recording media such as a magnetic recording medium, a magneto-optical recording medium and an optical recording medium; parts for display devices such as a liquid crystal display device, an organic EL device and an electrophoretic display device; parts for fuel cells; and the like.

Droplet Ejection Head

Now, a description will be made on an embodiment of a droplet ejection head in which the bonded body according to the present invention is used.

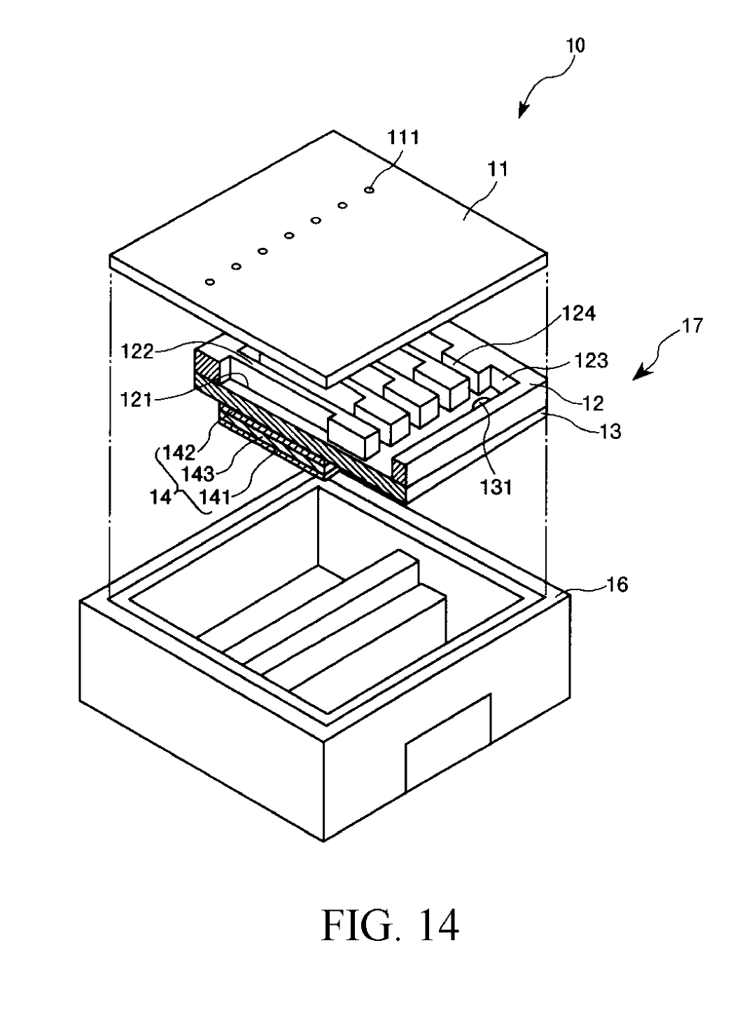

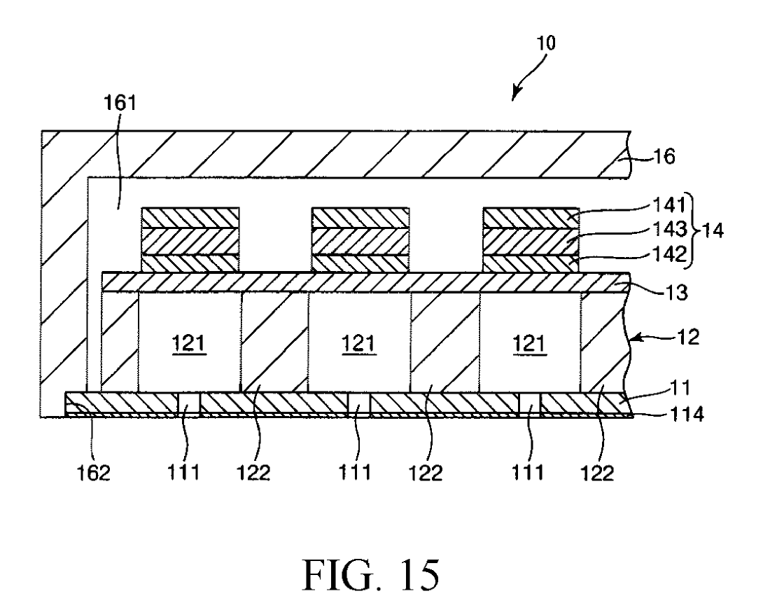

FIG. 14 is an exploded perspective view showing an ink jet type recording head (a droplet ejection head) in which the bonded body according to the present invention is used. FIG. 15 is a section view illustrating major parts of the ink jet type recording head shown in FIG. 14.

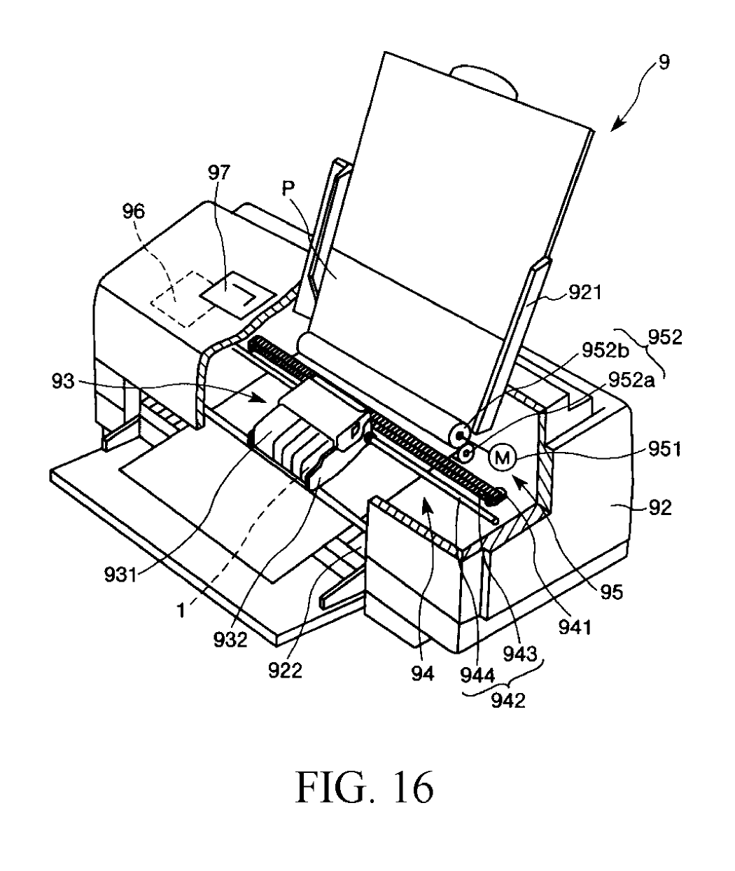

FIG. 16 is a schematic view showing one embodiment of an ink jet printer equipped with the ink jet type recording head shown in FIG. 14. In FIG. 14, the ink jet type recording head is shown in an inverted state as distinguished from a typical use state.

The ink jet type recording head 10 shown in FIG. 14 is mounted to the ink jet printer 9 shown in FIG. 16.

The ink jet printer 9 shown in FIG. 16 includes a printer body 92, a tray 921 provided in the upper rear portion of the printer body 92 for holding recording paper sheets P, a paper discharging port 922 provided in the lower front portion of the printer body 92 for discharging the recording paper sheets P therethrough, and an operation panel 97 provided on the upper surface of the printer body 92.

The operation panel 97 is formed from, e.g., a liquid crystal display, an organic EL display, an LED lamp or the like. The operation panel 97 includes a display portion (not shown) for displaying an error message and the like and an operation portion (not shown) formed from various kinds of switches.

Within the printer body 92, there are provided a printing device (a printing means) 94 having a reciprocating head unit 93, a paper sheet feeding device (a paper sheet feeding means) 95 for feeding the recording paper sheets P into the printing device 94 one by one and a control unit (a control means) 96 for controlling the printing device 94 and the paper sheet feeding device 95.

Under the control of the control unit 96, the paper sheet feeding device 95 feeds the recording paper sheets P one by one in an intermittent manner. The recording paper sheet P passes near the lower portion of the head unit 93. At this time, the head unit 93 makes reciprocating movement in a direction generally perpendicular to the feeding direction of the recording paper sheet P, thereby printing the recording paper sheet P.

In other words, an ink jet type printing operation is performed, during which time the reciprocating movement of the head unit 93 and the intermittent feeding of the recording paper sheets P act as primary scanning and secondary scanning, respectively.

The printing device 94 includes a head unit 93, a carriage motor 941 serving as a driving power source of the head unit 93 and a rotated by the carriage motor 941 for reciprocating the head unit 93.

The head unit 93 includes an ink jet type recording head 10 (hereinafter, simply referred to as “a head 10”) having a plurality of formed in the lower portion thereof, an ink cartridge 931 for supplying ink to the head 10 and a carriage 932 carrying the head 10 and the ink cartridge 931.

Full color printing becomes available by using, as the ink cartridge 931, a cartridge of the type filled with ink of four colors, i.e., yellow, cyan, magenta and black.

The reciprocating mechanism 942 includes a carriage guide shaft 943 whose opposite ends are supported on a frame (not shown) and a timing belt 944 extending parallel to the carriage guide shaft 943.

The carriage 932 is reciprocatingly supported by the carriage guide shaft 943 and fixedly secured to a portion of the timing belt 944.

If the timing belt 944 wound around a pulley is caused to run in forward and reverse directions by operating the carriage motor 941, the head unit 93 makes reciprocating movement along the carriage guide shaft 943. During this reciprocating movement, an appropriate amount of ink is ejected from the head 10 to print the recording paper sheets P.

The paper sheet feeding device 95 includes a paper sheet feeding motor 951 serving as a driving power source thereof and a pair of paper sheet feeding rollers 952 rotated by means of the paper sheet feeding motor 951.

The paper sheet feeding rollers 952 include a driven roller 952a and a driving roller 952b, both of which face toward each other in a vertical direction, with a paper sheet feeding path (the recording paper sheet P) remained therebetween. The driving roller 952b is connected to the paper sheet feeding motor 951.

Thus, the paper sheet feeding rollers 952 are able to feed the plurality of recording paper sheets P, which are held in the tray 921, toward the printing device 94 one by one. In place of the tray 921, it may be possible to employ a construction that can removably hold a paper sheet feeding cassette containing the recording paper sheets P.

The control unit 96 is designed to perform printing by controlling the printing device 94 and the paper sheet feeding device 95 based on the printing data inputted from a host computer, e.g., a personal computer or a digital camera.

Although not shown in the drawings, the control unit 96 is mainly comprised of a memory that stores a control program for controlling the respective parts and the like, a piezoelectric element driving circuit for driving piezoelectric elements (vibration sources) 14 to control an ink ejection timing, a driving circuit for driving the printing device 94 (the carriage motor 941), a driving circuit for driving the paper sheet feeding device 95 (the paper sheet feeding motor 951), a communication circuit for receiving printing data from a host computer, and a CPU electrically connected to the memory and the circuits for performing various kinds of control with respect to the respective parts.

Electrically connected to the CPU are a variety of sensors capable of detecting, e.g., the remaining amount of ink in the ink cartridge 931 and the position of the head unit 93.

The control unit 96 receives printing data through the communication circuit and then stores them in the memory. The CPU processes these printing data and outputs driving signals to the respective driving circuits, based on the data thus processed and the data inputted from the variety of sensors. Responsive to these signals, the piezoelectric elements 14, the printing device 94 and the paper sheet feeding device 95 come into operation, thereby printing the recording paper sheets P.

Hereinafter, the head 10 will be described in detail with reference to FIGS. 14 and 15.

The head 10 includes a head main body 17 and a base body 16 for receiving the head main body 17. The head main body 17 includes a nozzle plate 11, an ink chamber base plate 12, a vibration plate 13 and a plurality of piezoelectric elements (vibration sources) 14 bonded to the vibration plate 13. The head 10 constitutes a piezo jet type head of on-demand style.

The nozzle plate 11 is made of, e.g., a silicon-based material such as SiO₂, SiN or quartz glass, a metallic material such as Al, Fe, Ni, Cu or alloy containing these metals, an oxide-based material such as alumina or ferric oxide, a carbon-based material such as carbon black or graphite. and the like.

A plurality of nozzle holes 111 for ejecting ink droplets therethrough is formed in the nozzle plate 11. The pitch of the nozzle holes 111 is suitably set according to the degree of printing accuracy.

The ink chamber base plate 12 is fixed or secured to the nozzle plate 11. In the ink chamber base plate 12, there are formed a plurality of ink chambers (cavities or pressure chambers) 121, a reservoir chamber 123 for reserving ink supplied from the ink cartridge 931 and a plurality of supply ports 124 through which ink is supplied from the reservoir chamber 123 to the respective ink chambers 121. These chambers 121, 123 and 124 are defined by the nozzle plate 11, the side walls (barrier walls) 122 and the below mentioned vibration plate 13.

The respective ink chambers 121 are formed into a reed shape (a rectangular shape) and are arranged in a corresponding relationship with the respective nozzle holes 111. Volume of each of the ink chambers 121 can be changed in response to vibration of the vibration plate 13 as described below. Ink is ejected from the ink chambers 121 by virtue of this volume change.

As a base material of which the ink chamber base plate 12 is made, it is possible to use, e.g., a monocrystalline silicon substrate, various kinds of glass substrates or various kinds of resin substrates. Since these substrates are all generally used in the art, use of these substrates makes it possible to reduce manufacturing cost of the head 10.

The vibration plate 13 is bonded to the opposite side of the ink chamber base plate 12 from the nozzle plate 11. The plurality of piezoelectric elements 14 are provided on the opposite side of the vibration plate 13 from the ink chamber base plate 12.

In a predetermined position of the vibration plate 13, a communication hole 131 is formed through a thickness of the vibration plate 13. Ink can be supplied from the ink cartridge 931 to the reservoir chamber 123 through the communication hole 131.

Each of the piezoelectric elements 14 includes an upper electrode 141, a lower electrode 142 and a piezoelectric body layer 143 interposed between the upper electrode 141 and the lower electrode 142. The piezoelectric elements 14 are arranged in alignment with the generally central portions of the respective ink chambers 121.

The piezoelectric elements 14 are electrically connected to the piezoelectric element driving circuit and are designed to be operated (vibrated or deformed) in response to the signals supplied from the piezoelectric element driving circuit.

The piezoelectric elements 14 act as vibration sources. The vibration plate 13 is vibrated by operation of the piezoelectric elements 14 and has a function of instantaneously increasing internal pressures of the ink chambers 121.

The base body 16 is made of, e.g., various kinds of resin materials or various kinds of metallic materials. The nozzle plate 11 is fixed to and supported by the base body 16. Specifically, in a state that the head main body 17 is received in a recess portion 161 of the base body 16, an edge of the nozzle plate 11 is supported on a shoulder 162 of the base body 16 extending along an outer circumference of the recess portion 161.

When bonding the nozzle plate 11 and the ink chamber base plate 12, the ink chamber base plate 12 and the vibration plate 13, and the nozzle plate 11 and the base body 16 as mentioned above, the bonding method of the present invention is used in at least one bonding point.

In other words, the bonded body of the present invention is used in at least one of a bonded body in which the nozzle plate 11 and the ink chamber base plate 12 are bonded together, a bonded body in which the ink chamber base plate 12 and the vibration plate 13 are bonded together, and a bonded body in which the nozzle plate 11 and the base body 16 are bonded together.

The head 10 described above exhibits increased bonding strength and chemical resistance in a bonding surface of the bonded portion, which in turn leads to increased durability and liquid tightness against the ink reserved in the respective ink chambers 121. As a result, the head 10 is rendered highly reliable.

Furthermore, highly reliable bonding is available even at an extremely low temperature. This is advantageous in that a head with an increased area can be fabricated from those materials having different linear expansion coefficients.

With the head 10 set forth above, no deformation occurs in the piezoelectric body layer 143 in the case where a predetermined ejection signal has not been inputted from the piezoelectric element driving circuit, that is, a voltage has not been applied between the upper electrode 141 and the lower electrode 142 of each of the piezoelectric elements 1.

For this reason, no deformation occurs in the vibration plate 13 and no change occurs in the volumes of the ink chambers 121. Therefore, ink droplets have not been ejected from the nozzle holes 111.

On the other hand, the piezoelectric body layer 143 is deformed in the case where a predetermined ejection signal is inputted from the piezoelectric element driving circuit, that is, a voltage is applied between the upper electrode 141 and the lower electrode 142 of each of the piezoelectric elements 1.

Thus, the vibration plate 13 is heavily deflected to change the volumes of the ink chambers 121. At this moment, the pressures within the ink chambers 121 are instantaneously increased and ink droplets are ejected from the nozzle holes 111.

When one ink ejection operation has ended, the piezoelectric element driving circuit ceases to apply a voltage between the upper electrode 141 and the lower electrode 142. Thus, the piezoelectric elements 14 are returned substantially to their original shapes, thereby increasing the volumes of the ink chambers 121.

At this time, a pressure acting from the ink cartridge 931 toward the nozzle holes 111 (a positive pressure) is imparted to the ink. This prevents an air from entering the ink chambers 121 through the nozzle holes 111, which ensures that the ink is supplied from the ink cartridge 931 (the reservoir chamber 123) to the ink chambers 121 in a quantity corresponding to the quantity of ink ejected.

By sequentially inputting ejection signals from the piezoelectric element driving circuit to the piezoelectric elements 14 lying in target printing positions, it is possible to print an arbitrary (desired) letter, figure or the like.

The head 10 may be provided with thermoelectric conversion elements in place of the piezoelectric elements 14. In other words, the head 10 may have a configuration in which ink is ejected using the thermal expansion of a material caused by thermoelectric conversion elements (which is sometimes called a bubble jet method wherein the term “bubble jet” is a registered trademark).

In the head 10 configured as above, a film 114 is formed on the nozzle plate 11 in an effort to impart liquid repellency thereto. By doing so, it is possible to reliably prevent ink droplets from adhering to peripheries of the nozzle holes 111, which would otherwise occur when the ink droplets are ejected from the nozzle holes 111.

As a result, it becomes possible to make sure that the ink droplets ejected from the nozzle holes 111 are reliably landed (hit) on target regions.

Although the base member, the bonding method and the bonded body according to the present invention have been described above based on the embodiments illustrated in the drawings, the present invention is not limited thereto.

As an alternative example, the bonding method according to the present invention may be a combination of two or more of the foregoing embodiments. If necessary, one or more arbitrary step may be added in the bonding method according to the present invention.

Further, although cases that two members (e.g., the base member and the opposite substrate, the two base members) are bonded together has been described in the above embodiments, the base member and the bonding method of the present invention can be used in a case that three or more members are bonded together.

### EXAMPLES

Next, a description will be made on a number of concrete examples of the present invention.

1. Manufacturing Bonded Body

Hereinafter, twenty bonded bodies are manufactured in each of Examples and Comparative Examples.

### Example 1

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, the monocrystalline silicon substrate was set in the chamber 111 of the film forming apparatus 100 shown in FIG. 5 and subjected to a surface treatment using oxygen plasma.

Next, a bonding film having an average thickness of 200 nm was formed on the surface-treated surface of the monocrystalline silicon substrate. In this regard, it is to be noted that the film forming conditions were as follows.

Film Forming Conditions

A composition of a raw gas is octamethyltrisiloxane, a flow rate of the raw gas is 50 sccm, a composition of a carrier gas is argon, a flow rate of the carrier gas is 100 sccm, an output of a high-frequency electricity is 100 W, a density of the high-frequency electricity is 25 W/cm², a pressure inside a chamber is 1 Pa (low vacuum), a time of forming a film is 15 minutes, and a temperature of the monocrystalline silicon substrate is 20° C.

The plasma polymerization film formed as described above was constituted of a polymer of octamethyltrisiloxane (raw gas). The polymer contained siloxane bonds, a Si-skeleton of which constituent atoms were bonded, and alkyl groups (elimination groups) in a chemical structure thereof. In this way, a base member in which the plasma polymerization film was formed on the monocrystalline silicon substrate was obtained.

Likewise, after glass substrate was subjected to the surface treatment using oxygen plasma, a plasma polymerization film was also formed on the surface-treated surface of the glass substrate. In this way, a base member was obtained.

Then, an ultraviolet ray was irradiated on the obtained plasma polymerization films under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and a irradiation time of the ultraviolet ray is 5 minutes.

Next, after 1 minute of the ultraviolet ray irradiation, the monocrystalline silicon substrate was laminated to the glass substrate so that the surface of the plasma polymerization film of the monocrystalline silicon substrate, to which the ultraviolet ray had been irradiated, was in contact with the surface of the plasma polymerizations film of the glass substrate, to which the ultraviolet ray had been irradiated. As a result, a bonded body was obtained.

Then, the bonded body thus obtained was heated at a temperature of 80° C. while pressuring the same under a pressure of 3 MPa and was maintained for fifteen minutes to thereby increase bonding strength between the monocrystalline silicon substrate and the glass substrate.

### Example 2

In Example 2, a bonded body was manufactured in the same manner as in the Example 1, except that the heating temperature was changed from 80° C. to 25° C. during the pressuring and heating of the bonded body obtained.

### Examples 3 to 12

In each of Examples 3 to 12, a bonded body was manufactured in the same manner as in the Example 1, except that the constitute material of the substrate and the constitute material of the opposite substrate were changed to materials shown in Table 1.

### Example 13

First, in the same manner as in the Example 1, a monocrystalline silicon substrate (a substrate) and a glass substrate (an opposite substrate) were prepared and subjected to a surface treatment using oxygen plasma.

Then, a plasma polymerization film was formed on the surface-treated surface of each of the monocrystalline silicon substrate and the glass substrate in the same manner as in the Example 1.

In this way, obtained were two base members in which the plasma polymerization film was formed on each of the monocrystalline silicon substrate and the glass substrate (the base member of the present invention).

Subsequently, the two base members were laminated together so that the plasma polymerization films of the two base members made contact with each other to thereby obtain a pre-bonded body.

Next, an ultraviolet ray was irradiated to the pre-bonded body from the side of the glass substrate under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and a irradiation time of the ultraviolet ray is 5 minutes.

In this way, the two base members were bonded together to thereby obtain a bonded body.

Then, the bonded body thus obtained was heated at a temperature of 80° C. while pressuring the same under a pressure of 3 MPa and was maintained for fifteen minutes to thereby increase bonding strength between the base members.

### Example 14

In Example 14, a bonded body was manufactured in the same manner as in the Example 1, except that the output of the high-frequency electricity was changed to 150 W (output density of the high-frequency voltage was changed 37.5 W/cm²).

### Example 15

In Example 15, a bonded body was manufactured in the same manner as in the Example 1, except that the output of the high-frequency electricity was changed to 200 W (output density of the high-frequency voltage was changed 50 W/cm²).

### Example 16

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, the monocrystalline silicon substrate were set in the chamber 101 of the film forming apparatus 100 shown in FIG. 5 and subjected to a surface treatment using oxygen plasma.

Next, a plasma polymerization film having an average thickness of 200 nm was formed on the surface-treated surfaces of the monocrystalline silicon substrate. In this regard, it is to be noted that the film forming conditions were as follows.

Film Forming Conditions

A composition of a raw gas is octamethyltrisiloxane, a flow rate of the raw gas is 50 sccm, a composition of a carrier gas is argon, a flow rate of the carrier gas is 100 sccm, an output of a high-frequency electricity is 100 W, a density of the high-frequency electricity is 25 W/cm², a pressure inside a chamber is 1 Pa (low vacuum), a time of forming a film is 15 minutes, and a temperature of the monocrystalline silicon substrate is 20° C.

Then, an ultraviolet ray was irradiated on the obtained plasma polymerization film under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and a irradiation time of the ultraviolet ray is 5 minutes.

Next, after 1 minute of the ultraviolet ray irradiation, the monocrystalline silicon substrate was laminated to the glass substrate so that the surface of the plasma polymerization film of the monocrystalline silicon substrate, to which the ultraviolet ray had been irradiated, was in contact with the surface of the glass substrate. As a result, a bonded body was obtained.

Then, the bonded body thus obtained was heated at a temperature of 80° C. while pressuring the same under a pressure of 3 MPa and was maintained for fifteen minutes to thereby increase bonding strength between the plasma polymerization film of the monocrystalline silicon substrate (base member) and the glass substrate.

### Example 17

In Example 17, a bonded body was manufactured in the same manner as in the Example 16, except that the heating temperature was changed from 80° C. to 25° C. during the pressuring and heating of the bonded body obtained.

### Examples 18 to 27

In each of Examples 18 to 27, a bonded body was manufactured in the same manner as in the Example 16, except that the constitute material of the substrate and the constitute material of the opposite substrate were changed to materials shown in Table 1.

### Example 28

First, in the same manner as in the Example 16, a monocrystalline silicon substrate (a substrate) and a glass substrate (an opposite substrate) were prepared and subjected to a surface treatment using oxygen plasma.

Then, a plasma polymerization film was formed on the surface-treated surfaces of the monocrystalline silicon substrate in the same manner as in the Example 16. In this way, obtained was a base member in which the plasma polymerization film was formed on the monocrystalline silicon substrate (the base members of the present invention).

Subsequently, the monocrystalline silicon substrate and the glass substrate were laminated together so that the plasma polymerization film of the monocrystalline silicon substrate made contact with the surface-treated surface of the glass substrate to thereby obtain a pre-bonded body.

Next, an ultraviolet ray was irradiated to the pre-bonded body from the side of the glass substrate under the following conditions.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and a irradiation time of the ultraviolet ray is 5 minutes.

In this way, the two base members were bonded together to thereby obtain a bonded body.

Then, the bonded body thus obtained was heated at a temperature of 80° C. while pressuring the same under a pressure of 3 MPa and was maintained for fifteen minutes to thereby increase bonding strength between the monocrystalline silicon substrate and the glass substrate.

### Example 29

In the Example 29, a bonded body was manufactured in the same manner as in the Example 16, except that the output of the high-frequency electricity was changed to 150 W (output density of the high-frequency voltage was changed 37.5 W/cm²).

### Example 30

In the Example 30, a bonded body was manufactured in the same manner as in the Example 16, except that the output of the high-frequency electricity was changed to 200 W (output density of the high-frequency voltage was changed 50 W/cm²).

### Example 31

First, a monocrystalline silicon substrate having a length of 20 mm, a width of 20 mm and an average thickness of 1 mm was prepared as a substrate. A glass substrate having a length of 20 mm, a width of 20 mm and an average thickness of 1 mm was prepared as an opposite substrate.

Subsequently, both of the monocrystalline silicon substrate and the glass substrate were set in the chamber 101 of the film forming apparatus 100 shown in FIG. 5, and subjected to a surface treatment using oxygen plasma.

Next, plasma polymerization films each having an average thickness of 200 nm were formed on the surface-treated surfaces of the monocrystalline silicon substrate and the glass substrate to obtain base members. In this regard, it is to be noted that the film forming conditions were as follows.

Film Forming Conditions

A composition of a raw gas is octamethyltrisiloxane, a flow rate of the raw gas is 50 sccm, a composition of a carrier gas is argon, a flow rate of the carrier gas is 100 sccm, an output of a high-frequency electricity is 100 W, a density of the high-frequency electricity is 25 W/cm², a pressure inside a chamber is 1 Pa (low vacuum), a time of forming a film is 15 minutes, and a temperature of the base material is 20° C.

Then, an ultraviolet ray was irradiated on the obtained plasma polymerization films under the following conditions.

In this regard, it is to be noted that the ultraviolet ray was irradiated on the entirety of the surface of the plasma polymerization film provided on the monocrystalline silicon substrate and on a frame-shaped region having a width of 3 mm along a periphery of the surface of the plasma polymerization film provided on the glass substrate.

Ultraviolet Ray Irradiation Conditions

A composition of an atmospheric gas is an atmosphere (air), a temperature of the atmospheric gas is 20° C., a pressure of the atmospheric gas is atmospheric pressure (100 kPa), a wavelength of the ultraviolet ray is 172 nm, and a irradiation time of the ultraviolet ray is 5 minutes.

Subsequently, the monocrystalline silicon substrate and the glass substrate were laminated together so that the ultraviolet ray-irradiated surfaces of the plasma polymerization films made contact with each other to thereby obtain a bonded body.

Then, the bonded body thus obtained was heated at a temperature of 80° C. while pressuring the same under a pressure of 3 MPa and was maintained for fifteen minutes to thereby increase bonding strength between the plasma polymerization films.

### Example 32

In the Example 32, a bonded body was manufactured in the same manner as in the Example 31, except that the heating temperature was changed from 80° C. to 25° C. during the pressuring and heating of the bonded body obtained.

### Examples 33 to 38

In each of the Examples 33 to 38, a bonded body was manufactured in the same manner as in the Example 31, except that the constitute material of the substrate and the constitute material of the opposite substrate were changed to materials shown in Table 2.

### Example 39

First, a monocrystalline silicon substrate having a length of 20 mm, a width of 20 mm and an average thickness of 1 mm was prepared as a substrate. A stainless steel substrate having a length of 20 mm, a width of 20 mm and an average thickness of 1 mm was prepared as an opposite substrate.

Subsequently, the monocrystalline silicon substrate was set in the chamber 101 of the film forming apparatus 100 shown in FIG. 5 and subjected to a surface treatment using oxygen plasma.

Next, a plasma polymerization film having an average thickness of 200 nm was formed on the surface-treated surface of the monocrystalline silicon substrate in the same manner as in the Example 31.

In this way, obtained was a base member in which the plasma polymerization film was formed on the monocrystalline silicon substrate (the base member of the present invention).

Then, an ultraviolet ray was irradiated on the plasma polymerization film in the same manner as in the Example 31. In this regard, it is to be noted that the ultraviolet ray was irradiated on a frame-shaped region having a width of 3 mm along a periphery of the surface of the plasma polymerization film.

Further, the stainless steel substrate was also subjected to the surface treatment using oxygen plasma in the same manner as employed in the monocrystalline silicon substrate.

Subsequently, the base member and the stainless steel substrate were laminated together so that the ultraviolet ray-irradiated surface of the plasma polymerization film and the surface-treated surface of the stainless steel substrate made contact with each other to thereby obtain a bonded body.

Then, the bonded body thus obtained was heated at a temperature of 80° C. while pressuring the same under a pressure of 3 MPa and was maintained for fifteen minutes to thereby increase bonding strength between the plasma polymerization film and the stainless steel substrate.

### Example 40

In the Example 40, a bonded body was manufactured in the same manner as in the Example 39, except that the heating temperature was changed from 80° C. to 25° C. during the pressuring and heating of the bonded body obtained.

### Examples 41 to 43

In each of the Examples 41 to 43, a bonded body was manufactured in the same manner as in the Example 39, except that the constitute material of the substrate and the constitute material of the opposite substrate were changed to materials shown in Table 2.

### Comparative Examples 1 to 3

In each of the Comparative Examples 1 to 3, a bonded body was manufactured in the same manner as in the Example 1, except that the constitute material of the substrate and the constitute material of the opposite substrate were changed to materials shown in Table 1, and the substrate and the opposite substrate were bonded together using an epoxy-based adhesive.

### Comparative Examples 4 to 6

In each of the Comparative Examples 4 to 6, a bonded body was manufactured in the same manner as in the Example 1, except that the constitute material of the substrate and the constitute material of the opposite substrate were changed to materials shown in Table 2, and the substrate and the opposite substrate were partially bonded together using an epoxy-based adhesive in regions each having a width of 3 mm along a periphery of each substrate.

### Comparative Example 7

In the Comparative Example 7, a bonded body was manufactured in the same manner as in the Example 1, except that the following bonding film was formed on a monocrystalline silicon substrate and a glass substrate instead of the plasma polymerization film.

First, prepared was a liquid material which contains a material having a polydimethylsiloxane skeleton as a silicone material and toluene and isobutanol as a solvent (“KR-251” produced by Shin-Etsu Chemical Co., Ltd., a viscosity (at 25° C.) is 18.0 mPa·S).

Subsequently, after a surface of the monocrystalline silicon substrate was subjected to a surface treatment using oxygen plasma, the liquid material was applied onto the surface-treated surface of the monocrystalline silicon substrate. Next, the applied liquid material was dried at room temperature (25° C.) for 24 hours to obtain a bonding film.

Likewise, after a surface of the glass substrate was subjected to the surface treatment using the oxygen plasma, a bonding film was formed on the surface-treated surface. An ultraviolet ray was irradiated to the surface of each of the bonding films.

Thereafter, the monocrystalline silicon substrate and the glass substrate were heated while pressing them so that the bonding films adhere to each other. In this way, a bonded body was obtained, in which the monocrystalline silicon substrate was bonded to the glass substrate through the bonding films.

### Comparative Examples 8 to 13

In each of the Comparative Examples 8 to 13, a bonded body was manufactured in the same manner as in the Comparative Example 7, except that the constituent materials of the substrate and the opposite substrate were changed to materials shown in Table 1.

### Comparative Example 14

In the Comparative Example 14, a bonded body was manufactured in the same manner as in the Example 1, except that the following bonding film was formed on a monocrystalline silicon substrate and a glass substrate instead of the plasma polymerization film.

First, after a surface of the monocrystalline silicon substrate was subjected to a surface treatment using oxygen plasma, a vapor of hexamethyldisilazane (HMDS) was applied to the surface-treated surface of the monocrystalline silicon substrate to obtain a bonding film constituted of HMDS.

Likewise, after a surface of the glass substrate was subjected to the surface treatment using the oxygen plasma, a bonding film constituted of HMDS was formed on the surface-treated surface of the glass substrate. An ultraviolet ray was irradiated to the surface of each of the bonding films.

Thereafter, the monocrystalline silicon substrate and the glass substrate were heated while pressing them so that the bonding films adhered to each other. In this way, a bonded body was obtained, in which the monocrystalline silicon substrate was bonded to the glass substrate through the bonding films.

2. Evaluation of Bonded Body

2.1 Evaluation of Bonding Strength (Splitting Strength)

Bonding strength was measured for each of the bonded bodies obtained in the Examples 1 to 43 and the Comparative Examples 1 to 14.

The measurement of the bonding strength was performed by trying removal of the substrate from the opposite substrate. That is, the measurement of the bonding strength was performed just before the substrate was removed from the opposite substrate. Further, the measurement of the bonding strength was performed just after the substrate and the opposite substrate were bonded to each other.

Furthermore, the bonded body, that a temperature cycle in the range of −40 to 125° C. was repeatedly performed thereto 50 times just after the substrate and the opposite substrate were bonded to each other, was used for the measurement of the bonding strength. The Result of the bonding strength was evaluated according to criteria described below.

In this regard, the bonding strength between the substrate and the opposite substrate in the bonded body which was obtained by partially bonding the surfaces of them to each other (bonded body defined in Table 2) was larger than the bonding strength between the substrate and the opposite substrate in the bonded body which was obtained by bonding the entire surfaces of them to each other (bonded body defined in Table 1).

Evaluation Criteria for Bonding Strength

A: 10 MPa (100 kgf/cm²) or more

B: 5 MPa (50 kgf/cm²) or more, but less than 10 MPa (100 kgf/cm²)

C: 1 MPa (10 kgf/cm²) or more, but less than 5 MPa (50 kgf/cm²)

D: less than 1 MPa (10 kgf/cm²)

2.2 Evaluation of Dimensional Accuracy

Dimensional accuracy in a thickness direction was measured for each of the bonded bodies obtained in the Examples 1 to 43 and the Comparative Examples 1 to 14.

The evaluation of the dimensional accuracy was performed by measuring a thickness of each corner portion of the bonded body having a squire shape, calculating a difference between a maximum value and a minimum value of the thicknesses measured, and evaluating the difference according to criteria described below.

Evaluation Criteria for Dimensional Accuracy

A: less than 10 μm

D: 10 μm or more

2.3 Evaluation of Chemical Resistance

Ten of the bonded bodies obtained in each of the Examples 1 to 43 and the Comparative Examples 1 to 14 were immersed in an ink for an ink-jet printer (“HQ4”, produced by Seiko Epson Corporation), which was maintained at a temperature of 80° C., for three weeks. Further, the others (ten bonded bodies) were immersed in the same ink as that described above for 50 days.

Thereafter, the substrate was removed from the opposite substrate, and it was checked whether or not the ink penetrated into a bonding interface of each bonded body. The Result of the check was evaluated according to criteria described below.

Evaluation Criteria for Chemical Resistance

A: Ink did not penetrate into the bonded body at all.

B: Ink penetrated into the corner portions of the bonded body slightly.

C: Ink penetrated along the edge portions of the bonded body.

D: Ink penetrated into the inside of the bonded body.

2.4 Evaluation of Crystallinity Degree

In each of the bonded bodies obtained in the Examples 1 to 43 and the Comparative Examples 1 to 14, crystallinity degree of the Si-skeleton included in the bonding film thereof was measured. The obtained crystallinity degree was evaluated according to criteria described below.

Evaluation Criteria for Crystallinity Degree

A: The crystallinity degree was 30% or less.

B: The crystallinity degree was 30% or more, but lower than 45%.

C: The crystallinity degree was 45% or more, but lower than 55%.

D: The crystallinity degree was 55% or more.

2.5 Evaluation of Infrared Adsorption (FT-IR)

In each of the bonded bodies obtained in the Examples 1 to 43 and the Comparative Examples 1 to 14, the bonding film of the bonded body was subjected to a infrared adsorption method to obtain an infrared adsorption spectrum having peaks. The following items (1) and (2) were calculated by using the infrared adsorption spectrum.

The item (1) is a relative intensity of a peak derived from Si—H bonds with respect to a peak derived from siloxane (Si—O) bonds. The item (2) is a relative intensity of a peak derived from methyl groups (CH₃ bonds) with respect to the peak derived from the siloxane bonds.

2.6 Evaluation of Refractive Index

In each of the bonded bodies obtained in the Examples 1 to 43 and the Comparative Examples 1 to 14, a refractive index of the bonding film of the bonded body was measured.

2.7 Evaluation of Light Transmission Rate

In each of the bonded bodies obtained in the Examples 1 to 43 and the Comparative Examples 1 to 14, a light transmission rate of the bonded body which can be subjected to a light transmission rate measurement apparatus was measured. The obtained light transmission rate was evaluated according to criteria described below.

Evaluation Criteria for Light Transmission Rate

A: The light transmission rate was 95% or more.

B: The light transmission rate was 90% or more, but lower than 95%.

C: The light transmission rate was 85% or more, but lower than 90%.

D: The light transmission rate was lower than 85%.

2.8 Evaluation of Shape Change

Shape changes of the substrate and the opposite substrate were checked for each of the bonded bodies obtained in the Examples 31 to 43 and the Comparative Examples 4 to 6 before and after the bonded body was manufactured.

Specifically, warp amounts of the substrate and the opposite substrate were measured before and after the bonded body was manufactured, a change between the warp amounts was evaluated according to criteria described below.

Evaluation Criteria for Change Between Warp Amounts

A: The warp amounts of the substrate and the opposite substrate were not changed hardly before and after the bonded body was manufactured.

B: The warp amounts of the substrate and the opposite substrate were changed slightly before and after the bonded body was manufactured.

C: The warp amounts of the substrate and the opposite substrate were changed rather significantly before and after the bonded body was manufactured.

D: The warp amounts of the substrate and the opposite substrate were changed significantly before and after the bonded body was manufactured.

Evaluation results of the above items 2.1 to 2.8 are shown in Tables 1 and 2.

TABLE 1

| | Conditions of manufacturing bonded body | | | | | | | |
|---|---|---|---|---|---|---|---|---|
| | Bonding film | | | | | | | |
| | | | | Output density | | Constituent | | |
| | Constituent | | | of high- | Postions of | material of | | |
| | material of | | | frequency | forming | opposite | Irradiation of | Heating |
| | substrate | Embodiment | Composition | voltage (W/cm²) | bonding film | substrate | ultraviolet ray | temperature |
| Ex. 1 | Silicon | Plasma | Octamethyl- | 25 (100 W) | Both | Glass | Before | 80° C. |
| Ex. 2 | Silicon | polymerization | trisiloxane | | substrate | Glass | laminating | 25° C. |
| Ex. 3 | Silicon | film | | | and opposite | Silicon | substrate and | 80° C. |
| Ex. 4 | Silicon | | | | substrate | Stainless | opposite | 80° C. |
| | | | | | | steel | substrate | |
| Ex. 5 | Silicon | | | | | Alminum | | 80° C. |
| Ex. 6 | Silicon | | | | | PET | | 80° C. |
| Ex. 7 | Silicon | | | | | PI | | 80° C. |
| Ex. 8 | Glass | | | | | Glass | | 80° C. |
| Ex. 9 | Glass | | | | | Stainless | | 80° C. |
| | | | | | | steel | | |
| Ex. 10 | Stainless | | | | | PET | | 80° C. |
| | steel | | | | | | | |
| Ex. 11 | Stainless | | | | | PI | | 80° C. |
| | steel | | | | | | | |
| Ex. 12 | Stainless | | | | | Alminum | | 80° C. |
| | steel | | | | | | | |
| Ex. 13 | Silicon | | | | | Glass | After | 80° C. |
| | | | | | | | laminating | |
| | | | | | | | substrate and | |
| | | | | | | | opposite | |
| | | | | | | | substrate | |
| Ex. 14 | Silicon | | | 37.5 (150 W) | | Glass | Before | 80° C. |
| Ex. 15 | Silicon | | | 50 (200 W) | | Glass | laminating | 80° C. |
| | | | | | | | substrate and | |
| | | | | | | | opposite | |
| | | | | | | | substrate | |
| Ex. 16 | Silicon | | | 25 (100 W) | Only | Glass | Before | 80° C. |
| Ex. 17 | Silicon | | | | substrate | Glass | laminating | 25° C. |
| Ex. 18 | Silicon | | | | | Silicon | substrate and | 80° C. |
| Ex. 19 | Silicon | | | | | Stainless | opposite | 80° C. |
| | | | | | | steel | substrate | |
| Ex. 20 | Silicon | | | | | Alminum | | 80° C. |
| Ex. 21 | Silicon | | | | | PET | | 80° C. |
| Ex. 22 | Silicon | | | | | PI | | 80° C. |
| Ex. 23 | Glass | | | | | Glass | | 80° C. |
| Ex. 24 | Glass | | | | | Stainless | | 80° C. |
| | | | | | | steel | | |
| Ex. 25 | Stainless | | | | | PET | | 80° C. |
| | steel | | | | | | | |
| Ex. 26 | Stainless | | | | | PI | | 80° C. |
| | steel | | | | | | | |
| Ex. 27 | Stainless | | | | | Alminum | | 80° C. |
| | steel | | | | | | | |
| Ex. 28 | Silicon | | | | | Glass | After | 80° C. |
| | | | | | | | laminating | |
| | | | | | | | substrate and | |
| | | | | | | | opposite | |
| | | | | | | | substrate | |
| Ex. 29 | Silicon | | | 37.5 (150 W) | | Glass | Before | 80° C. |
| Ex. 30 | Silicon | | | 50 (200 W) | | Glass | laminating | 80° C. |
| | | | | | | | substrate and | |
| | | | | | | | opposite | |
| | | | | | | | substrate | |
| Comp. Ex. 1 | Silicon | Adhesive | Epoxy-based | — | — | Glass | — | — |
| Comp. Ex. 2 | Silicon | | adhesive | | | Silicon | | |
| Comp. Ex. 3 | Silicon | | | | | Stainless | | |
| | | | | | | steel | | |
| Comp. Ex. 7 | Silicon | Coating film | Polyorganosiloxane- | — | Both | Glass | Before | 80° C. |
| Comp. Ex. 8 | Silicon | | based material | | substrate | Stainless | laminating | 80° C. |
| | | | | | and opposite | steel | substrate and | |
| Comp. Ex. 9 | Silicon | | | | substrate | PET | opposite | 80° C. |
| Comp. Ex. 10 | Glass | | | | | Glass | substrate | 80° C. |
| Comp. Ex. 11 | Stainless | | | | | Glass | | 80° C. |
| | steel | | | | | | | |
| Comp. Ex. 12 | Stainless | | | | | Stainless | | 80° C. |
| | steel | | | | | steel | | |
| Comp. Ex. 13 | Stainless | | | | | PET | | 80° C. |
| | steel | | | | | | | |
| Comp. Ex. 14 | Silicon | Vapor- | Polysilozane | — | | Glass | | 80° C. |
| | | deposited film | | | | | | |

| | Evaluation results | | | | | | | | | |
|---|---|---|---|---|---|---|---|---|---|---|
| | Bonding strength | | | | | | | | | |
| | | After | | | | | | | | |
| | Just | performing | | Chemical resistance | | Crystal- | | | | Light |
| | after | temperature | Dimensional | After | After | linity | Si—H/ | CH₃/ | Refractive | transmission |
| | bonding | cycle | accuracy | 3 weeks | 50 days | degree | Si—O—Si | Si—O—Si | index | rate |
| Ex. 1 | B | B | A | A | A | A | 0.02 | 0.22 | 1.44 | — |
| Ex. 2 | B | B | A | A | A | A | 0.02 | 0.22 | 1.44 | — |
| Ex. 3 | B | B | A | A | A | A | 0.02 | 0.22 | 1.44 | — |
| Ex. 4 | B | B | A | A | A | A | 0.02 | 0.22 | 1.44 | — |
| Ex. 5 | B | B | A | A | A | A | 0.02 | 0.22 | 1.44 | — |
| Ex. 6 | A | A | A | A | B | A | 0.02 | 0.22 | 1.44 | — |
| Ex. 7 | A | A | A | A | B | A | 0.02 | 0.22 | 1.44 | — |
| Ex. 8 | B | B | A | A | A | A | 0.02 | 0.22 | 1.44 | A |
| Ex. 9 | B | B | A | A | A | A | 0.02 | 0.22 | 1.44 | — |
| Ex. 10 | A | A | A | A | B | A | 0.02 | 0.22 | 1.44 | — |
| Ex. 11 | A | A | A | A | B | A | 0.02 | 0.22 | 1.44 | — |
| Ex. 12 | B | B | A | A | A | A | 0.02 | 0.22 | 1.44 | — |
| Ex. 13 | B | B | A | A | A | A | 0.02 | 0.22 | 1.44 | — |
| Ex. 14 | B | B | A | A | B | A | 0.02 | 0.20 | 1.45 | — |
| Ex. 15 | B | C | A | A | C | B | 0.03 | 0.17 | 1.49 | — |
| Ex. 16 | B | CB | A | A | BA | A | 0.02 | 0.22 | 1.44 | — |
| Ex. 17 | B | CB | A | A | BA | A | 0.02 | 0.22 | 1.44 | — |
| Ex. 18 | B | CB | A | A | BA | A | 0.02 | 0.22 | 1.44 | — |
| Ex. 19 | B | CB | A | A | BA | A | 0.02 | 0.22 | 1.44 | — |
| Ex. 20 | B | CB | A | A | BA | A | 0.02 | 0.22 | 1.44 | — |
| Ex. 21 | A | BA | A | A | CB | A | 0.02 | 0.22 | 1.44 | — |
| Ex. 22 | A | BA | A | A | CB | A | 0.02 | 0.22 | 1.44 | — |
| Ex. 23 | B | CB | A | A | BA | A | 0.02 | 0.22 | 1.44 | A |
| Ex. 24 | B | CB | A | A | BA | A | 0.02 | 0.22 | 1.44 | — |
| Ex. 25 | A | BA | A | A | CB | A | 0.02 | 0.22 | 1.44 | — |
| Ex. 26 | A | BA | A | A | CB | A | 0.02 | 0.22 | 1.44 | — |
| Ex. 27 | B | CB | A | A | BA | A | 0.02 | 0.22 | 1.44 | — |
| Ex. 28 | B | CB | A | A | BA | A | 0.02 | 0.22 | 1.44 | — |
| Ex. 29 | B | CB | A | A | BA | A | 0.02 | 0.20 | 1.45 | — |
| Ex. 30 | B | CB | A | A | CB | B | 0.03 | 0.17 | 1.49 | — |
| Comp. Ex. 1 | A | D | D | C | D | — | — | — | — | — |
| Comp. Ex. 2 | A | D | D | C | D | — | — | — | — | — |
| Comp. Ex. 3 | A | D | D | C | D | — | — | — | — | — |
| Comp. Ex. 7 | B | D | D | B | C | C | 0 | 0.49 | 1.56 | — |
| Comp. Ex. 8 | B | D | D | B | C | C | 0 | 0.49 | 1.56 | — |
| Comp. Ex. 9 | B | D | D | B | D | C | 0 | 0.49 | 1.56 | — |
| Comp. Ex. 10 | B | D | D | B | C | C | 0 | 0.49 | 1.56 | D |
| Comp. Ex. 11 | B | D | D | B | C | C | 0 | 0.49 | 1.56 | — |
| Comp. Ex. 12 | B | D | D | B | C | C | 0 | 0.49 | 1.56 | — |
| Comp. Ex. 13 | B | D | D | B | D | C | 0 | 0.49 | 1.56 | — |
| Comp. Ex. 14 | C | D | A | C | D | C | 0 | — | — | — |

 PET: Polyethyrene terephathalate
PI: Polyimide
In evaluation results, the symbol “BA” represents that the evaluation results of both B and A are mixed.

TABLE 2

| | Conditions of manufacturing bonded body | | | | | | | | |
|---|---|---|---|---|---|---|---|---|---|
| | | Bonding film | | | | | | | |
| | | | | Output density | | | Constituent | Irradiation | |
| | Constituent | | | of high- | | Positions of | material of | of | |
| | material of | | | frequency | Bonding | forming | opposite | ultraviolet | Heating |
| | substrate | Embodiment | Composition | voltage (W/cm²) | region | bonding film | substrate | ray | temperature |
| Ex. 31 | Silicon | Plasma | Octamethyl- | 25 (100 W) | A part of | Both | Glass | Before | 80° C. |
| Ex. 32 | Silicon | polymerization | trisiloxane | | bonding | substrate | Glass | laminating | 25° C. |
| Ex. 33 | Silicon | film | | | surface | and opposite | Silicon | substrate and | 80° C. |
| Ex. 34 | Silicon | | | | | substrate | PET | opposite | 80° C. |
| Ex. 35 | Silicon | | | | | | PI | substrate | 80° C. |
| Ex. 36 | Glass | | | | | | Glass | | 80° C. |
| Ex. 37 | Stainless | | | | | | PET | | 80° C. |
| | steel | | | | | | | | |
| Ex. 38 | Stainless | | | | | | PI | | 80° C. |
| | steel | | | | | | | | |
| Ex. 39 | Silicon | | | | | Only | Stainless | | 80° C. |
| | | | | | | substrate | steel | | |
| Ex. 40 | Silicon | | | | | | Stainless | | 25° C. |
| | | | | | | | steel | | |
| Ex. 41 | Silicon | | | | | | Alminum | | 80° C. |
| Ex. 42 | Glass | | | | | | Stainless | | 80° C. |
| | | | | | | | steel | | |
| Ex. 43 | Stainless | | | | | | Alminum | | 80° C. |
| | steel | | | | | | | | |
| Comp. Ex. 4 | Silicon | Adhesive | Epoxy-based | — | A part of | — | Glass | — | — |
| Comp. Ex. 5 | Silicon | | adhesive | | bonding | | Silicon | | |
| Comp. Ex. 6 | Silicon | | | | surface | | Stainless | | |
| | | | | | | | steel | | |

| | Evaluation results | | | | | | | | |
|---|---|---|---|---|---|---|---|---|---|
| | | Chemical resistance | | Warp | Crystal- | | | | Light |
| | Dimensional | After 3 | After | amounts | linity | Si—H/ | CH₃/ | Refractive | transmission |
| | accuracy | weeks | 50 days | change | degree | Si—O—Si | Si—O—Si | index | rate |
| Ex. 31 | A | A | A | A | A | 0.02 | 0.22 | 1.44 | — |
| Ex. 32 | A | A | A | A | A | 0.02 | 0.22 | 1.44 | — |
| Ex. 33 | A | A | A | A | A | 0.02 | 0.22 | 1.44 | — |
| Ex. 34 | A | A | B | B | A | 0.02 | 0.22 | 1.44 | — |
| Ex. 35 | A | A | B | B | A | 0.02 | 0.22 | 1.44 | — |
| Ex. 36 | A | A | A | A | A | 0.02 | 0.22 | 1.44 | A |
| Ex. 37 | A | A | B | B | A | 0.02 | 0.22 | 1.44 | — |
| Ex. 38 | A | A | B | B | A | 0.02 | 0.22 | 1.44 | — |
| Ex. 39 | A | A | BA | B | A | 0.02 | 0.22 | 1.44 | — |
| Ex. 40 | A | A | BA | A | A | 0.02 | 0.22 | 1.44 | — |
| Ex. 41 | A | A | BA | B | A | 0.02 | 0.22 | 1.44 | — |
| Ex. 42 | A | A | BA | B | A | 0.02 | 0.22 | 1.44 | — |
| Ex. 43 | A | A | BA | A | A | 0.02 | 0.22 | 1.44 | — |
| Comp. Ex. 4 | D | C | D | A | — | 0.02 | 0.22 | 1.44 | — |
| Comp. Ex. 5 | D | C | D | A | — | 0.02 | 0.22 | 1.44 | — |
| Comp. Ex. 6 | D | C | D | B | — | 0.02 | 0.22 | 1.44 | — |

 PET: Polyethyrene terephathalate
PI: Polyimide
In evaluation results, the symbol “BA” represents that the evaluation results of both B and A are mixed.

As is apparent in Tables 1 and 2, the bonded bodies obtained in the examples 1 to 43 exhibited excellent characteristics in all the items of the bonding strength, the dimensional accuracy, the chemical resistance, and the light transmission rate. Further, in each of the bonded bodies obtained in the Examples 1 to 43, the bonding film is produced by the plasma polymerization method.

Therefore, it was conceived that the reason why the bonded bodies obtained in the Examples 1 to 43 exhibited the superior characteristics was caused by characteristics a plasma polymerization film (bonding film) exhibits.

Furthermore, in each of the bonded bodies obtained in the Examples 1 to 43, it was confirmed that the Si—H bonds were included in the bonding film based on the analysis of the infrared adsorption spectrum. Furthermore, it was confirmed that the crystallinity degree of the bonding film in which the Si—H bonds were included was low.

As descried above, it was conceived that the reason why the bonded bodies obtained in the Examples 1 to 43 exhibited the superior characteristics was caused by the low crystallinity degree of the Si-skeleton (the constituent atoms of the bonding film are more bonded to each other) with the inclusion of the Si—H bonds in the bonding film which was formed by the plasma polymerization method.

Furthermore, in each of the bonded bodies obtained in the Examples 1 to 43, it was confirmed that the refractive index was changed by changing the output density of the high-frequency voltage during the formation of the bonding film.

On the other hand, the bonded bodies obtained in the Comparative Examples 1 to 14 did not have enough chemical resistance, bonding strength and light transmission rate. Further, it was also confirmed that the dimensional accuracy of the bonded bodies was particularly low.

### INDUSTRIAL APPLICABILITY

A base member including a bonding film according to the present invention includes a substrate and the bonding film provided on the substrate. Such a bonding film contains a Si-skeleton constituted of constituent atoms containing silicon atoms and elimination groups bonded to the silicon atoms of the Si-skeleton. The Si-skeleton includes siloxane (Si—O) bonds. The constituent atoms of the Si-skeleton are bonded to each other.

Further, the bonding film is formed by a plasma polymerization method. Furthermore, in a case where energy is applied to at least a part region of the surface of the bonding film, the elimination groups existing on the surface and in the vicinity of the surface within the region are removed from the silicon atoms of the Si-skeleton so that the region develops bonding property with respect to an object.

Therefore, it is possible to obtain a base member including a bonding film that can be firmly bonded to an object with high dimensional accuracy and efficiently bonded to the object at a low temperature.

Further, since the bonding film includes the Si-skeleton including the siloxane bonds, of which constituent atoms are bonded to each other, it is difficult for the bonding film to deform, thereby providing a firm bonding film. Therefore, high bonding strength, chemical resistance, and dimensional accuracy are obtained in the bonding film in itself.

Also in the bonded body in which the base member and the object are bonded to each other, high bonding strength, chemical resistance, and dimensional accuracy are obtained. Accordingly, the base member according to the present invention has industrial applicability.

What is claimed is:

1. A base member including a bonding film having a surface, the base member to be bonded to an object through the bonding film, and the base member comprising:
a substrate; and
the bonding film provided on the substrate, the bonding film containing a Si-skeleton constituted of constituent atoms containing silicon atoms and elimination groups bonded to the silicon atoms of the Si-skeleton, the Si-skeleton including siloxane (Si—O) bonds, wherein the constituent atoms are bonded to each other;
wherein the bonding film is formed by a plasma polymerization, and
wherein in a case where an energy is applied to at least a part region of the surface of the bonding film, the elimination groups existing on the surface and in the vicinity of the surface within the region are removed from the silicon atoms of the Si-skeleton so that the region develops a bonding property with respect to the object.

2. The base member as claimed in claim 1, wherein the constituent atoms have hydrogen atoms and oxygen atoms, a sum of a content of the silicon atoms and a content of the oxygen atoms in the constituent atoms other than the hydrogen atoms is in the range of 10 to 90 atom % in the bonding film.

3. The base member as claimed in claim 1, wherein the constituent atoms have oxygen atoms, and an abundance ratio of the silicon atoms and the oxygen atoms is in the range of 3:7 to 7:3 in the bonding film.

4. The base member as claimed in claim 1, wherein a crystallinity degree of the Si-skeleton is equal to or lower than 45%.

5. The base member as claimed in claim 1, wherein the Si-skeleton of the bonding film contains Si—H bonds.

6. The base member as claimed in claim 5, wherein in the case where the bonding film containing the Si-skeleton containing the Si—H bonds is subjected to an infrared absorption measurement by an infrared adsorption measurement apparatus to obtain an infrared absorption spectrum having peaks, in a case where an intensity of the peak derived from the siloxane bond in the infrared absorption spectrum is defined as “1”, an intensity of the peak derived from the Si—H bond in the infrared absorption spectrum is in the range of 0.001 to 0.2.

7. The base member as claimed in claim 1, wherein the elimination groups are constituted of at least one selected from the group consisting of a hydrogen atom, a boron atom, a carbon atom, a nitrogen atom, an oxygen atom, a phosphorus atom, a sulfur atom, a halogen-based atom and an atom group which is arranged so that these atoms are bonded to the Si-skeleton.

8. The base member as claimed in claim 7, wherein the elimination groups are an alkyl group containing a methyl group.

9. The base member as claimed in claim 8, wherein in the case where the bonding film containing the methyl groups as the elimination groups is subjected to an infrared absorption measurement by an infrared absorption measurement apparatus to obtain an infrared absorption spectrum having peaks, in a case where an intensity of the peak derived from the siloxane bond in the infrared absorption spectrum is defined as “1”, an intensity of the peak derived from the methyl group in the infrared absorption spectrum is in the range of 0.05 to 0.45.

10. The base member as claimed in claim 1, wherein active hands are generated on the silicon atoms of the Si-skeleton of the bonding film, after the elimination groups existing at least in the vicinity of the surface of the bonding film are removed from the silicon atoms of the Si-skeleton.

11. The base member as claimed in claim 10, wherein the active hands are dangling bonds or hydroxyl groups.

12. The base member as claimed in claim 1, wherein the bonding film is constituted of polyorganosiloxane as a main component of the bonding film.

13. The base member as claimed in claim 12, wherein the polyorganosiloxane is constituted of a polymer of octamethyltrisiloxane as a main component of the polyorganosiloxane.

14. The base member as claimed in claim 1, wherein the plasma polymerization includes a high frequency applying process and a plasma generation process, and a power density of the high frequency during the plasma generation process is in the range of 0.01 to 100 W/cm².

15. The base member as claimed in claim 1, wherein an average thickness of the bonding film is in the range of 1 to 1000 nm.

16. The base member as claimed in claim 1, wherein the bonding film is a solid-state film having no fluidity.

17. The base member as claimed in claim 1, wherein a refractive index of the bonding film is in the range of 1.35 to 1.6.

18. The base member as claimed in claim 1, wherein the substrate has a plate shape.

19. The base member as claimed in claim 1, wherein at least a portion of the substrate on which the bonding film is formed is constituted of a silicon material, a metal material or a glass material as a main component of the substrate.

20. The base member as claimed in claim 1, wherein the substrate has a surface on which the bonding film is provided, and the surface of the substrate has been, in advance, subjected to a surface treatment for improving bonding strength between the substrate and the bonding film.

21. The base member as claimed in claim 20, wherein the surface treatment is a plasma treatment.

22. The base member as claimed in claim 1 further comprising an intermediate layer provided between the substrate and the bonding film.

23. The base member as claimed in claim 22, wherein the intermediate layer is constituted of an oxide-based material as a main component of the intermediate layer.

24. A bonding method of forming a bonded body, the bonding method comprising:
providing the base member defined in claim 1 and the object;
applying an energy to at least the part region of the surface of the bonding film included in the base member so that the region develops a bonding property with respect to the object; and
making the object and the base member close contact with each other through the bonding film, so that the object and the base member are bonded together due to the bonding property developed in the region, to thereby obtain the bonded body.

25. A bonding method of forming a bonded body, the bonding method comprising:
providing the base member defined in claim 1 and the object;
making the object and the base member close contact with each other through the bonding film to obtain a pre-bonded body in which the object and the base member are laminated together; and
applying an energy to at least the part region of the surface of the bonding film in the pre-bonded body, so that the region develops a bonding property with respect to the object and the object and the base member are bonded together due to the bonding property developed in the region, to thereby obtain the bonded body.

26. The bonding method as claimed in claim 24, wherein the applying the energy is carried out by at least one method selected from the group comprising a method in which an energy beam is irradiated on the bonding film, a method in which the bonding film is heated and a method in which a compressive force is applied to the bonding film.

27. The bonding method as claimed in claim 26, wherein the energy beam is an ultraviolet ray having a wavelength of 150 to 300 nm.

28. The bonding method as claimed in claim 26, wherein a temperature of the heating is in the range of 25 to 100° C.

29. The bonding method as claimed in claim 26, wherein the compressive force is in the range of 0.2 to 10 MPa.

30. The bonding method as claimed in claim 24, wherein the applying the energy is carried out in an atmosphere.

31. The bonding method as claimed in claim 24, wherein the object has a surface which has been, in advance, subjected to a surface treatment for improving bonding strength between the object and the base member, and
wherein the bonding film included in the base member makes close contact with the surface-treated surface of the object.

32. The bonding method as claimed in claim 24, wherein the object has a surface containing at least one group or substance selected from the group comprising a functional group, a radical, an open circular molecule, an unsaturated bond, a halogen atom and peroxide, and
wherein the bonding film included in the base member makes close contact with the surface having the group or substance of the object.

33. The bonding method as claimed in claim 24 further comprising subjecting the bonded body to a treatment for improving bonding strength between the base member and the object.

34. The bonding method as claimed in claim 33, wherein the subjecting the bonded body to the treatment is carried out by at least one method selected from the group comprising a method in which an energy beam is irradiated on the bonded body, a method in which the bonded body is heated and a method in which a compressive force is applied to the bonded body.

35. A bonded body, comprising:
the base member defined in claim 1; and
an object bonded to the base member through the bonding film of the base member.
